(19) United States
(12) Patent Application Publication
(10) Pub. No.: US 2009/0047576 A1
(43) Pub. Date: Feb. 19, 2009

(54) Nickel Metal-Hydride Battery and Method of Manufacturing the Same

(75) Inventors: Kazuya Okabe, Kyoto (JP); Toshinori Bandou, Kyoto (JP); Hiroaki Mori, Kyoto (JP); Kouichi Sakamoto, Kyoto (JP)

Correspondence Address: KANESAKA BERNER AND PARTNERS LLP, 1700 DIAGONAL RD, SUITE 310, ALEXANDRIA, VA, 22314-2848, US

(73) Assignee: GS Yuasa Corporation, Kyoto (JP)

(21) Appl. No.: 11/988,231

(22) PCT Filed: Jun. 30, 2006
(86) PCT No.: PCT/JP2006/313526

§ 371 Date: Jan. 3, 2008

(51) Int. Cl. H01M 4/58; H01M 4/88; H01M 2/08

(52) U.S. Cl. 429/174; 429/218.2; 252/182.1

(57) ABSTRACT

An object of the present invention is to provide a sealed nickel metal-hydride that shows an excellent output power performance, while maintaining an excellent charge/discharge cycle performance, and a method of manufacturing the same.

A hydrogen absorbing electrode is made of hydrogen absorbing alloy powder containing rare earth elements and Ni and other metal elements other than rare earth elements and the hydrogen absorbing alloy powder shows a specific saturation mass susceptibility and a specific content ratio of the rare earth elements to the non-rare earth elements. A nickel metal-hydride battery is formed by using such a hydrogen absorbing electrode and welding at least the welded points of the inner surface of a sealing plate and a current collecting lead or the welded points of the current collecting lead and an upper current collecting plate by causing an electric current to flow between the positive electrode terminal and the negative electrode terminal of the battery from an external power source after sealing the battery.

### TECHNICAL FIELD

The present invention relates to a nickel metal-hydride battery. More particularly, the present invention relates to a nickel metal-hydride battery having an excellent output power performance and an excellent charge/discharge characteristic and a method of manufacturing the same.

### BACKGROUND ART

Electronic equipment including mobile electronic devices such as mobile computers and digital cameras are required to be downsized and lightweight and the market of electromotive equipment has been rapidly growing in recent years. Sealed nickel metal-hydride batteries provide energy per unit volume and unit mass higher than nickel-cadmium cells and lead accumulators and are excellent in terms of resistance against over-charges and over-discharges so that they are popularly being used as environment-friendly clean power sources of such electromotive equipment. Additionally, sealed nickel metal-hydride batteries are finding applications in the field of power sources of hybrid type electric vehicles (HEVs), electric tools and electric toys that used to be nickel-cadmium cells and require high output power performance and a long service life.

Nickel metal-hydride batteries desirably show an output density not less than 400 W/kg, preferably not less than 600 W/kg, at a low temperature (e.g., 0° C.) for applications having a heavy load such as power sources of HEVs and electric tools. Additionally, the nickel metal-hydride battery installed in a HEV at a position where the temperature of the ambient air can be raised desirably has a cycle life of not less than 400 cycles, preferably not less than 500 cycles, at a high temperature (e.g., 45° C.).

Among various hydrogen absorbing alloys, LaNi₅ based hydrogen absorbing alloys have been and being popularly used for hydrogen absorbing electrodes of nickel metal-hydride batteries because such alloys show a high discharge capacity and an excellent cycle performance.

For instance, hydrogen absorbing alloys produced by using Mm (misch-metal) in place of La and/or replacing Ni partly by a metal element such as Co, Al or Mn are being popularly used for nickel metal-hydride batteries in order to lower the price and improve the durability. Of hydrogen absorbing alloys based on Mm, those whose La content ratio relative to Mm is not less than 80 wt % have been popular because such alloys have a large capacity per unit weight. However, known hydrogen absorbing electrodes show a large reaction resistance at discharges and nickel metal-hydride batteries formed by using such hydrogen absorbing electrodes are accompanied by a disadvantage that they are inferior relative to nickel cadmium batteries in terms of output power performance.

A negative electrode containing at least to hydrogen absorbing alloys that show different equilibrium hydrogen dissociation pressures has been proposed for the purpose of improving the high-rate discharge characteristics, while maintaining high temperature storage characteristic of batteries (see Patent Document 1).

Patent Document 1: JP-A 2000-149933 (paragraph [0020])

A negative electrode according to Patent Document 1 contains at least hydrogen absorbing alloys a and b whose equilibrium hydrogen dissociation pressures at 45° C. are different from each other when the negative electrode occludes hydrogen by 0.5 wt %. The Patent Document describes an instance where the equilibrium hydrogen dissociation pressure of the hydrogen absorbing alloy a is 0.3 MPa at 45° C., whereas the equilibrium hydrogen dissociation pressure of the hydrogen absorbing alloy b is 0.02 MPa at 45° C. when the negative electrode occludes hydrogen by 0.5 wt %. However, the cost high-rate discharge characteristic shown in Patent Document 1 is the discharge capacity when the battery is discharged at −20° C. at a discharge rate of 1 ItA (the ratio relative to the initial discharge capacity). In other words, the Patent Documents describes results obtained when the battery is discharged at a discharge rate lower than the rate employed for the method of evaluating the output power performance of a battery according to the present invention. Additionally, the Patent Document does not show the output power performance as defined for the purpose of the present invention (the output power performance (W) as determined from the 10th second voltage (the voltage observed after the start of a discharge)). More specifically, a simple use of hydrogen absorbing alloy powder showing a high equilibrium hydrogen dissociation pressure as part of rated hydrogen absorbing alloy powder as described in Patent Document 1 does not sufficiently improve the high-rate discharge ability probably because the charge transfer reaction on the surfaces of particles of hydrogen absorbing alloy powder is slow if such a technique is simply employed.

A nickel metal-hydride battery whose high-rate discharge ability and charge/discharge cycle performance are improved by using a negative electrode prepared by means of a mixture of hydrogen absorbing alloy powder of two different types showing different equilibrium hydrogen dissociation pressure and nickel powder has been proposed (see Patent Document 2).

Patent Document: JP-A 2004-281195 (paragraphs [0010] through [0012])

The equilibrium hydrogen dissociation pressure of the proposed hydrogen absorbing alloy at 60° C. is not lower than 0.65 MPa at highest and not higher than 0.1 MPa at lowest. According to the proposal, the high-rate discharge ability of a nickel metal-hydride battery can be improved without reducing the discharge capacity.

However, the high-rate discharge ability shown in Patent Document 2 is the magnitude of the discharge capacity when the battery is discharged at 5° C. at a rate of 10 ItA (the ratio relative to the initial discharge capacity at 20° C.) and the discharge temperature is higher than the low temperature level (e.g., 0° C.) of the present invention. Moreover, like Patent Document 1 and unlike the present invention, Patent Document 2 does not show any output power performance (W). If hydrogen absorbing alloy powder showing a high equilibrium hydrogen dissociation pressure is used as part of the hydrogen absorbing alloy powder of the battery and a field for accelerating the electrode reaction is provided by adding and mixing Ni powder, the effect of accelerating the electrode reaction is not sufficient probably because hydrogen absorbing alloy powder and Ni power are not bonded there.

A nickel metal-hydride battery containing hydrogen absorbing alloy, in which the La ratio relative to the total weight of the rare earth elements of the battery is 25 to 80 wt % or 25 to 60 wt % and the equilibrium hydrogen dissociation pressure at 40° C. is lower than 0.15 MPa or lower than 0.10 MPa is proposed. According to the proposal, there can be obtained a battery that is excellent in terms of durability at high temperatures and suppression of internal pressure rise and can suppress the rise of the internal resistance of the battery to show a remarkable cycle performance when the battery is subjected to charge/discharge cycles (e.g., refer to Patent Documents 3 and 4).

### Patent Document 3: JP-A 2003-317712

### Patent Document 4: JP-A 2004-119353

However, neither Patent Document 3 nor Patent Document 4 describes about the output power performance of battery. In other words, the inventions of the above Patent Documents are not aimed at improving the output power performance of a battery. Batteries described in the above Patent Documents are not suited for applications where the battery is subjected to high-rate discharges at low temperatures probably because the charge transfer reaction is slow on the surfaces of particles of hydrogen absorbing alloy powder and hence the reaction resistance of the hydrogen absorbing electrode is high.

There have been proposed nickel metal-hydride batteries having a hydrogen absorbing alloy electrode for which the surfaces of particles of hydrogen absorbing alloy powder containing La to a weight ratio of 40 to 70 wt % relative to all the rare earth elements in the alloy and showing an equilibrium pressure (equilibrium hydrogen plateau pressure at 45° C.) of 0.008 to 0.105 MPa are activated by stirring the hydrogen absorbing alloy powder at 80° C. in a KOH aqueous solution showing a specific weight of 1.30 for 1 hour. Nickel metal-hydride batteries realized by using such hydrogen absorbing alloy powder are reportedly excellent in terms of cycle performance and high-rate discharge characteristic. (e.g., refer to Patent Document 5.)

Patent Document 5: JP-A 07-286225 (paragraph [0014], Table 1)

However, Patent Document 5 does not specifically show any discharge temperature for high-rate discharges. Additionally, Patent Document 5 shows only the discharge capacity when the battery is discharged at 2 ItA (the ratio relative to the discharge capacity at 0.2 ItA) and, like Patent Documents 1 and 2, it does not show any output power performance. Furthermore, a Ni-rich layer is not formed satisfactorily on the surfaces of particles of hydrogen absorbing alloy powder if hydrogen absorbing alloy powder is immersed in KOH at 80° C. for 1 hour as shown in Patent Document 5 and the problem of a high reaction resistance of the hydrogen absorbing electrode is not dissolved. This may probably because the charge transfer reaction on the surfaces of particles of hydrogen absorbing alloy powder is slow as ever or the rate at which hydrogen is discharged from hydrogen absorbing alloy is restricted. While Patent Document 5 shows examples in which various different values were used for the AB ratio {B/A according to the present invention, or the ratio of B site elements (non-rare earth elements) to A site elements (rare earth elements)} and the equilibrium pressure (the equilibrium hydrogen dissociation pressure according to the present invention), the combinations cited there are those of a low AB ratio and a low equilibrium pressure and those of a high AB ratio and a high equilibrium pressure and such combinations may restrict the rate at which hydrogen is discharged from hydrogen absorbing alloy.

Alkali secondary batteries realized by using hydrogen absorbing alloy powder that has properties including an equilibrium pressure between 2 and 4 atm (0.2 and 0.4 MPa) at 100° C. and a saturation susceptibility between 3.4 and 9.0 emu/m² when immersed in an 8N KOH aqueous solution at 60° C. for 48 hours have been proposed. It is said that high capacity nickel metal-hydride batteries that show an excellent cycle performance and an excellent high-rate discharge characteristic at high temperatures can be obtained by using such hydrogen absorbing alloy powder. (e.g., refer to Patent Document 6.)

Patent Document 6: JP-A 2000-243434 (paragraphs [0011], [0012] and [0029], Table 1)

However, Patent Document 6 does not specifically describe any high-rate discharge characteristic and it is highly unlikely that the saturation susceptibility of hydrogen absorbing alloy powder having the above described properties gets to 3.4 to 9.0 emu/m² if hydrogen absorbing alloy powder is used unless the battery is left at high temperature for a long period of time or repeats a charge/discharge cycle for a number of times. Thus, such batteries have a drawback that an excellent high-rate discharge characteristic cannot be achieved unless the battery is aged at high temperature for a long time or unless a long time elapses since the start of the use thereof. Additionally, the ratio of B/A of hydrogen absorbing alloy powder shown in the examples is as small as 5.0 and the cycle performance is far from satisfactory probably because hydrogen absorbing alloy powder is corroded and/or micronized when a charge/discharge cycle is repeated for a number of times.

When a hydrogen absorbing alloy containing rare earth metals for absorbing and desorbing hydrogen, Ni and transition metal elements other than Ni are used for an electrode without being treated for activation, an activation process by tens to hundreds of charges/discharges is required because the initial activation is insufficient. Known hydrogen absorbing alloys are accompanied by a drawback that they are slow in activation and nickel metal-hydride batteries realized by using conventional negative electrodes show a poor charge/discharge cycle performance probably because hydrogen is generated excessively at the charge time to consume the electrolyte. A number of proposals have been made to activate hydrogen absorbing alloy powder and dissolve the problem of known hydrogen absorbing alloys that they are slow in activation. Hydrogen absorbing alloy powder is immersed in a weakly acidic aqueous solution according to one of such proposals. There is known a method of treating the surfaces of particles of hydrogen absorbing alloy powder by means of a weakly acidic aqueous solution with a pH value of 0.5 to 5. (e.g., refer to Patent Document 7.)

Patent Document 7: JP-A 07-73878 (paragraph [0011])

According to Patent Document 7, the coats of oxide or hydroxide formed on the surfaces of particles of hydrogen absorbing alloy powder are removed by an acid treatment to produce clean surfaces so that the activation level of the hydrogen absorbing electrode is improved to make it possible to shorten the activation process, although the effect of improving the battery life is not significant. This may be probably because the elements that are eluted by an acid treatment differ from the elements that are eluted by the aqueous solution of alkali metal that is the electrolyte used in the nickel metal-hydride battery so that hydrogen absorbing alloy powder is corroded by the alkaline electrolyte when a nickel metal-hydride battery is assembled by using hydrogen absorbing alloy powder that are treated by acid. The discharge ability at low temperature shown in the above-cited Patent Document is the discharge capacity (mAh) when discharged at a rate of 1 ItA at 0° C. (which is low if compared with the discharge rates in the evaluation of output power performance as will be described hereinafter). The above-cited Patent Document does not mention anything about output power performance.

There has been disclosed a method of immersing hydrogen absorbing alloy powder showing a Ni content ratio of 20 to 70 wt % in an aqueous sodium hydroxide solution whose sodium hydroxide concentration is between 30 and 80 wt % at temperature not lower than 90° C. in Patent Document 8 listed below. The Patent Document 8 also shows hydrogen absorbing alloy powder containing a magnetic material by 1.5 to 6 wt %. According to Patent Document 8, the oxides on the surfaces of particles of hydrogen absorbing alloy powder can be effectively removed by treating the starting material powder in a highly concentrated NaOH aqueous solution at high temperature with a short immersion period if compared with a treatment using a KOH aqueous solution. (e.g., refer to Patent Document 8.)

Patent Document 8: JP-A 2002-256301 (paragraph [0009])

While Patent Document 8 does not show anything about cycle performance at high temperatures (e.g., 45° C.), the cycle performance may presumably be not satisfactory because of the cycle performance at 25° C. shown there. Additionally, the high-rate discharge ability at low temperature shown in Patent Document 8 is the discharge capacity when the battery is discharged with an electric current that corresponds to 4 ItA at −10° C. to a discharge cut voltage of 0.6 V (which is lower than the discharge cut voltage of 0.8 V according to the present invention) and no output power performance is shown there. Patent Document 8 does not describe anything about equilibrium hydrogen dissociation pressure of hydrogen absorbing alloy powder and the invention of the patent document may highly probably be not able to show a remarkable effect on improvement of output power performance at low temperatures. Hydrogen absorbing electrodes containing hydrogen absorbing alloy powder immersed in an alkaline aqueous solution or a weakly acidic aqueous solution in advance and additionally isolated atoms or compound of Sm, Gd, Ho, Er and/or Yb that are weakly basic rare earth elements if compared with La have been proposed. (e.g., refer to Patent Documents 9 and 10.)

Patent Document 9: U.S. Pat. No. 6,136,473

### Patent Document 10: JP-A 09-7588

With the methods described in the above-cited patent documents, corrosion of hydrogen absorbing alloy can be suppressed to improve the cycle performance and the initial activation of a hydrogen absorbing electrode can be accelerated. However, neither Patent Document 9 nor Patent Document 10 mentions anything about output power performance. According to Patent Documents 9 and 10, the activation process of immersing hydrogen absorbing alloy powder in an alkaline aqueous solution or a weakly acidic aqueous solution is not controlled and the resistance against the charge transfer reaction of hydrogen absorbing alloy is not reduced sufficiently if the activation process is insufficient so that the effect of improving the output power performance may not be satisfactory. Conversely, the capacity of hydrogen absorbing alloy is reduced to make it difficult to secure a sufficiently reserved charge if the activation process is excessive so that again the effect of improving the cycle performance may not be satisfactory. Thus, it is difficult to achieve the target output power performance of the present invention by the methods of the above-cited Patent Documents probably because the hydrogen absorbed in a hydrogen absorbing alloy is strongly restricted and the reaction resistance of the hydrogen absorbing electrode is high.

In conventional cylindrical nickel metal-hydride batteries as shown in FIG. 4, the sealing plate 0 of a lid (which includes a hat-like cap 6, a sealing plate 0 and a valve 7 arranged in the space defined by the cap 6 and the sealing plate 0, a gasket 5 being fitted to the peripheral edge of the sealing plate 0, a peripheral part of the lid being clamped, the lid and the container being airtightly held in contact with each other by way of the gasket 5) that operates as one of the terminals (positive electrode terminal) and the upper current collecting plate (positive electrode collecting plate) 2 fitted to the upper rolled end of a rolled electrode assembly 1 are connected to each other by a ribbon-like current collecting lead 12 as shown in FIG. 5 (13 in FIG. 5 denotes the projections for welding arranged on the current collecting lead 12). For the illustrated conventional battery, the electrode assembly to which the upper current collecting plate is fitted is contained in the container 4 and subsequently one of the opposite ends of the ribbon-like current collecting lead 12, whose other end is welded to the upper current collecting plate, and the inner surface of the sealing plate 0 are welded to each other before the lid is mounted to the open end of the container 4 so that the current collecting lead 12 needs to be provided with a large extra curvature. Then, the current collecting lead 12 that connects the welded point of the ribbon-like current collecting lead 12 and the inner surface of the sealing plate 0 and the welded point of the ribbon-like current collecting lead 12 with the upper current collecting plate 2 is six to seven times longer than the gap between the sealing plate 0 and the upper current collecting plate 2. Such a long collecting lead itself has a large electric resistance and is one of the reasons of the low output power performance of the conventional nickel metal-hydride battery. The large electric resistance of the current collecting lead and that of the part of the collecting plate bonded to the inner surface of the container are another reason of the low output power performance of the conventional nickel metal-hydride battery.

As described above, although various proposals have been made on hydrogen absorbing electrodes in order to improve the characteristics of nickel metal-hydride batteries, no nickel metal-hydride battery that shows both an excellent cycle performance and an excellent output power performance has been realized to date.

### DISCLOSURE OF THE INVENTION

### Problem to be Solved by the Invention

In view of the above-identified problems of the conventional art, it is therefore the object of the present invention to provide a sealed nickel metal-hydride battery showing an excellent output power performance at low temperature that has never been proposed, while maintaining an excellent charge/discharge cycle performance.

### Means for Solving the Problem

The inventors of the present invention analyzed the resistance components that arise when a nickel metal-hydride battery is discharged at a high rate from the negative electrode thereof and found that the large reaction resistance of the hydrogen absorbing electrode of the prior art cannot be explained simply by the small reaction rate of the charge transfer reaction on the surfaces of particles of hydrogen absorbing alloy powder. Thus, the inventors of the present invention looked into providing hydrogen absorbing alloy powder with a catalyst function (catalyzing effect) and the composition that can facilitate movement (diffusion) of hydrogen, avoiding hydrogen from being strongly bound in hydrogen absorbing alloy, and lessen the moving distance of hydrogen in hydrogen absorbing alloy in order to reduce the reaction resistance of the charge transfer reaction. As a result, the inventors of the present invention found that the use of hydrogen absorbing alloy powder containing rare earth elements and metal elements other than rare earth elements including Ni and showing three specific values for the equilibrium hydrogen dissociation pressure, the saturation mass susceptibility and the B/A ratio thereof as defined below provides an excellent cycle performance and a remarkably excellent output power performance at low temperature. The present invention is based on this finding. The inventors of the present invention also found that the output power performance at low temperature of a sealed nickel metal-hydride battery can be more improved by using a negative electrode assembled by a specific method.

Thus, the present invention provides a nickel metal-hydride battery according to the present invention as defined below.

(1) A nickel metal-hydride battery including a nickel electrode operating as positive electrode and a hydrogen absorbing electrode containing hydrogen absorbing alloy powder and operating as negative electrode, characterized in that the hydrogen absorbing alloy powder contains a rare earth element and a no-rare earth metal element including nickel (Ni) and that, when the atomic ratio (H/M) of the hydrogen absorbed in the hydrogen absorbing alloy powder to the total metal elements contained in the hydrogen absorbing alloy powder is 0.5, the equilibrium hydrogen dissociation pressure is not less than 0.04 mega pascals (Mpa) and not more than 0.12 MPa at 40° C. and the saturation mass susceptibility of the hydrogen absorbing alloy powder is not less than 2 emu/g and not more than 6 emu/g, while the component ratio of the non-rare earth metal element to the rare earth element is not less than 5.10 and not more than 5.25 in terms of mol ratio. (refer to claim 1.)

The term of equilibrium hydrogen dissociation pressure as used herein refers to the equilibrium hydrogen dissociation pressure observed when 0.5 grams (g) of a powder sample of hydrogen absorbing alloy powder is accurately taken with a level of accuracy of 0.1 milligrams (mg), filled in a sample holder and observed at 40° C. by means of an automatic high pressure Sieverts instrument (PCT-A02 Type) for PCT measurements available from Toyobo Engineering with H/M=0.5.

The mol ratio representing the component ratio of the non-rare earth metal element to the rare earth element is the sum of the mole numbers of the non-rare earth metal elements contained in a certain amount of a hydrogen absorbing alloy/the sum of the mole numbers of the rare earth elements (the sum of the mol numbers are referred to as total mol number hereinafter).

(2) The nickel metal-hydride battery as defined in (1) above, characterized in that, when the atomic ratio (H/M) of the hydrogen occluded in the hydrogen absorbing alloy powder to the total metal elements contained in the hydrogen absorbing alloy powder is 0.5, the equilibrium hydrogen dissociation pressure is not less than 0.06 MPa and not more than 0.10 MPa at 0° C. (refer to claim 2.)
(3) The nickel metal-hydride battery as defined in (1) or (2) above, characterized in that the saturation mass susceptibility is not less than 3 emu/g and not more than 6 emu/g. (refer to claims 3 and 4.)
(4) The nickel metal-hydride battery as defined in any one of (1) through (3) above, characterized in that a hydrogen absorbing electrode contains the hydrogen absorbing alloy powder and oxide or oxides or hydroxide or hydroxides of Er and/or Yb added to and mixed with the hydrogen absorbing alloy powder. (refer to claim 5.)
(5) A method of manufacturing the nickel metal-hydride battery as defined in (1) or (3) above, characterized in that hydrogen absorbing alloy powder containing the rare earth element and non-rare earth metal element including nickel (Ni) is immersed in an alkali hydroxide aqueous solution at high temperature to make the saturation mass susceptibility thereof not less than 2 emu/g and not more than 6 emu/g or not less than 3 emu/g and not more than 6 emu/g. (refer to claims 6 and 7.)
(6) The nickel metal-hydride battery as defined in any one of (1) through (4) above, including a rolled electrode assembly and a cylindrical bottomed container having its open end sealed by a lid, the inner surface of the sealing plate of the lid and the upper surface of the upper current collecting plate fitted to the upper rolled end of the electrode assembly being connected to each other by way of a current collecting lead, characterized in that at least either the welded point of the inner surface of the sealing plate and the current collecting lead or the welded point of the current collecting lead and the upper current collecting plate is welded by causing an electric current to flow between the positive electrode terminal and the negative electrode terminal of the battery from an external power source by way of the inside of the battery after sealing the open end of the container. (refer to claims 8 and 9.)
(7) The nickel metal-hydride battery as defined in (6) above, characterized in that the current collecting lead and the upper current collecting plate are welded at a plurality of welded points, the ratio of the distance from the center of the upper current collecting plate to the welded points to the radius of the rolled electrode assembly is 0.4 to 0.7, a disk-shaped lower current collecting plate is fitted to the lower rolled end of the rolled electrode assembly and the lower current collecting plate and the inner surface of the container are welded at a plurality of welded points including one located at the center of the lower current collecting plate and ones located off the center of the lower current collecting plate, and the ratio of the distance from the plurality of welded points other than the one located at the center to the center of the lower current collecting plate to the radius of the rolled electrode assembly is 0.5 to 0.8. (refer to claims 10 and 11.)

### ADVANTAGES OF THE INVENTION

With the arrangement of (1) above, a nickel metal-hydride battery having a negative electrode showing an excellent cold output power performance can be obtained.

With the arrangement of (2) and (3) above, a nickel metal-hydride battery having a negative electrode showing a more excellent output power performance at low temperature can be obtained.

With the arrangement of (4) above, a nickel metal-hydride battery having a negative electrode showing an excellent output power performance at low temperature and an excellent charge/discharge cycle performance at high temperature can be obtained.

With the arrangement of (5) above, a nickel metal-hydride battery having a negative electrode showing an excellent output power performance at low temperature and an excellent charge/discharge cycle performance at high temperature can be obtained immediately after the assemblage of the battery.

With the arrangement of (6) and (7) above, a nickel metal-hydride battery having an even more excellent output power performance can be obtained.

### BRIEF DESCRIPTION OF THE DRAWINGS

FIG. 1 is a schematic illustration of the structure of a nickel metal-hydride battery according to the present invention and a method of welding the current collecting lead and the upper current collecting plate;

FIG. 2 is a front view of an example of a current collecting lead that can be used for a nickel metal-hydride battery according to the present invention;

FIG. 3 is a perspective view of an example of an upper current collecting plate that can be used for a nickel metal-hydride battery according to the present invention;

FIG. 4 is a schematic illustration of the cross sectional structure of a conventional cylindrical nickel metal-hydride battery;

FIG. 5 is a schematic perspective view of a ribbon-like current collecting lead;

FIG. 6 is a graph illustrating the relationship between the equilibrium hydrogen dissociation pressure of the hydrogen absorbing alloy powder and the output density of a nickel metal-hydride battery according to the present invention;

FIG. 7 is a graph illustrating the relationship among the equilibrium hydrogen dissociation pressure of the hydrogen absorbing alloy powder, the output density and the cycle performance of a nickel metal-hydride battery according to the present invention;

FIG. 8 is a graph illustrating the relationship among the saturation mass susceptibility of the hydrogen absorbing alloy powder, the output density and the cycle performance of a nickel metal-hydride battery according to the present invention; and

FIG. 9 is a graph illustrating the relationship among the content ratio (B/A) of the rare earth elements and the non-rare earth elements of the hydrogen absorbing alloy powder, the output density and the cycle performance of a nickel metal-hydride battery according to the present invention.

### EXPLANATION OF REFERENCE SYMBOLS

0: sealing plate
1: electrode assembly
2: upper current collecting plate
3: lower current collecting plate
4: container
5: gasket
6: cap
7: valve
8: main lead
9: supplementary lead
10, 11, 13, 14: projection
12: ribbon-like lead
A, B: output terminal of external power source (electric resistance welder)

### BEST MODE FOR CARRYING OUT THE INVENTION

### Hydrogen Absorbing Alloy Powder

Hydrogen absorbing alloy powder that is the principal component and the active material of the negative electrode is not subjected to any particular limitations so long as it contains rare earth elements and Ni as component elements and operates to absorb and desorb hydrogen. Preferably, however, it is powder of an AB₅ type alloy of which Ni of the MmNi₅ (where Mm represents a misch-metal that is a mixture of rare earth elements) is substituted partly by Co, Mn, Al and/or Cu because powder of such an alloy shows an excellent cycle life performance and a large discharge capacity.

According to the present invention, hydrogen absorbing alloy powder whose equilibrium hydrogen dissociation pressure at 40° C. is not less than 0.04 MPa when H/M=0.5 is used for the hydrogen absorbing electrode. A nickel metal-hydride battery can show a high output power performance in an atmosphere of 0° C. when the equilibrium hydrogen dissociation pressure is not less than 0.04 MPa. While the reason for this not clear yet, it may be safe to assume that the force binding hydrogen in hydrogen absorbing alloy is small to raise the rate at which hydrogen is discharged from the inside to the outside of the hydrogen absorbing alloy and reduce the reaction resistance of the hydrogen absorbing electrode in a discharge operation because of the high equilibrium hydrogen dissociation pressure. A higher output power performance can be achieved by using hydrogen absorbing alloy powder whose equilibrium hydrogen dissociation pressure is not less than 0.06 MPa at 40° C. when H/M=0.5.

However, the output density falls at 0° C. when the equilibrium hydrogen dissociation pressure is excessively high, although the reason for this is not known yet. Additionally, the capacity can prematurely fall probably because hydrogen is dissociated from the hydrogen absorbing ally to raise the pressure in the inside of the battery so that the internal pressure of the battery rises to allow the valve to easily open when only a small quantity of oxygen gas is generated in the final stages of a charge process and consequently the electrolyte is worn in an accelerated manner. The equilibrium hydrogen dissociation pressure of the hydrogen absorbing alloy powder of a nickel metal-hydride battery according to the present invention is not more than 0.12 MPa, preferably not more than 0.10 MPa, in order to maintain a high output density and prevent a premature fall of the capacity.

The equilibrium hydrogen dissociation pressure of the hydrogen absorbing alloy powder of a nickel metal-hydride battery id determined as a function of the composition of the powder. The method to be used for controlling the equilibrium hydrogen dissociation pressure of the hydrogen absorbing alloy of a nickel metal-hydride battery according to the present invention is not subjected to any particular limitations. For example, the equilibrium hydrogen dissociation pressure can be controlled by keeping the ratio of the total number of moles of the non-rare earth elements/the total number of moles of the rare earth elements (B/A) to a constant value and adjusting the ratio of La in the rare earth elements. Similarly, the equilibrium hydrogen dissociation pressure can be controlled by keeping the ratio of La in the rare earth elements to a constant value and adjusting the ratio of Al contained in the non-rare earth elements.

However, a high output power performance is not achieved simply by using hydrogen absorbing alloy powder that shows an equilibrium hydrogen dissociation pressure not less than 0.04 MPa for the hydrogen absorbing electrode. According to the present invention, an excellent output power performance can be achieved by using hydrogen absorbing alloy powder showing an equilibrium hydrogen dissociation pressure not less than 0.04 MPa and a saturation mass susceptibility between 2 and 6 emu/g, preferably between 3 and 6 emu/g. The saturation mass susceptibility of a hydrogen absorbing alloy is normally less than 0.1 emu/g. The inventors of the present invention believe that a high saturation mass susceptibility such as that of a hydrogen absorbing alloy according to the present invention can be produced when a phase rich of magnetizable metals such as Ni and Co is formed as layer on the surfaces of particles of hydrogen absorbing alloy powder. Hydrogen absorbing alloy powder showing such a high saturation mass susceptibility can be obtained by immersing hydrogen absorbing alloy powder containing Ni or Ni and Co in a hot alkali hydroxide aqueous solution heated to 90 to 110° C.

The saturation mass susceptibility is the value observed by accurately taking 0.3 g of hydrogen absorbing alloy powder, filling it in a sample holder and applying a magnetic field of 5 k oersteds by means of a vibrating sample magnetometer (Model BHV-30) available from Riken Electronics.

By observing hydrogen absorbing alloy powder after being immersed in a hot alkaline aqueous solution, it will be found that a phase rich of Ni or Ni and Co having a thickness of 100 nm or more had been formed as layer on the surfaces and in the fissures leading to the surfaces of particles of hydrogen absorbing alloy powder. While it is not clear yet why a high output can be obtained by using hydrogen absorbing alloy powder showing a high saturation mass susceptibility value, the inventors of the present invention believe that the phase rich of Ni or Ni and Co formed on the surfaces of particles of hydrogen absorbing alloy powder operates as catalyst for accelerating the charge transfer reaction that takes place during a discharge process and also as passageway for hydrogen in the hydrogen absorbing alloy powder to further accelerate the diffusion of hydrogen in the solid phase.

However, when the saturation mass susceptibility is excessively made high, while the charge transfer reaction is accelerated, the number of hydrogen absorbing sites of the hydrogen absorbing alloy can be reduced to by turn reduce the capacity of the negative electrode and the charge/discharge cycle performance can be degraded because the quantity of charge reserve is reduced. The effect of accelerating the operation of the catalyst for the charge transfer reaction and the diffusion of hydrogen in the solid phase may not be achieved when the saturation mass susceptibility is less than 2 emu/g. On the other hand, the capacity of the hydrogen absorbing alloy falls remarkably when the saturation mass susceptibility exceeds 6 emu/g. For this reason, the saturation mass susceptibility of the hydrogen absorbing alloy powder should be between 2 and 6 emu/g, preferably between 3 and 6 emu/g.

The value of the saturation mass susceptibility of the hydrogen absorbing alloy powder rises without immersing the hydrogen absorbing alloy powder in a hot alkaline aqueous solution as described above when a charge/discharge cycle is repeated after incorporating the hydrogen absorbing alloy powder into the battery. However, the saturation mass susceptibility rises slowly only at a low rate by such a repetition of the cycle and the charge/discharge cycle needs to be repeated tens or hundreds times before the level defined for the purpose of the present invention is reached. When the activeness of the hydrogen absorbing alloy is low as active material, the internal pressure of the battery rises to open the valve because of the poor hydrogen absorbing power and the performance can fall before a high output is achieved for the above described reason. Therefore, it is highly preferable to immerse the hydrogen absorbing alloy powder in a hot alkaline aqueous solution to raise the saturation mass susceptibility before it is incorporated into the battery.

According to the present invention, the ratio of B/A is not less than 5.10 and not more than 5.25. A high output can be achieved when the hydrogen absorbing alloy powder shows a equilibrium hydrogen dissociation pressure and a saturation mass susceptibility as described above and the ratio of B/A thereof is not more than 5.25. The reason for this is not very clear but the inventors of the present invention believe that, when the hydrogen absorbing alloy powder has the above described composition, fissures can easily be produced in the particles of the alloy powder during the process of causing the hydrogen absorbing alloy powder to absorb and discharge hydrogen so that fissures are actually produced in some of the particles of the alloy powder to increase the contact area of the alloy powder and the electrolyte and reduce the reaction resistance of the charge transfer reaction in the charge/discharge cycles for initial activation and the moving distance in the hydrogen absorbing alloy of the hydrogen that is occluded in the hydrogen absorbing alloy is reduced to additionally reduce the reaction resistance of the hydrogen absorbing electrode.

When the B/A ratio exceeds 5.25, it is difficult to achieve the effect of increasing the contact area between the alloy powder and the electrolyte and that of reducing the distance of the hydrogen passageway in the alloy powder so that a high output power performance cannot be obtained because fissures can hardly be produced, although durability of the hydrogen absorbing electrode is improved. Additionally, the hydrogen absorbing capacity of the hydrogen absorbing electrode is limited to reduce the total quantity of reserve so that the charge/discharge cycle performance of the battery can be degraded when the B/A ratio is greater than 5.25. The charge/discharge cycle performance can also be degraded when the B/A ratio is less than 5.10. While the reason for this is not clear, the inventors of the present invention believe that hydrogen absorbing alloy powder can easily and excessively be fissured to accelerate the micronization of hydrogen absorbing alloy powder and consequently and prematurely reduce the capacity when the B/A ratio is less than 5.10 and the cycle of occluding and discharging hydrogen is repeated.

It has been believed hitherto that the average particle size of the powder of the negative electrode active material (hydrogen absorbing alloy) is preferably reduced. It is normally less than 20 μm, preferably less than 10 μm. However, when the average particle size of the hydrogen absorbing alloy powder is made less than 20 μm or even less than 10 μm, the corrosion of the hydrogen absorbing alloy powder is accelerated to give rise to a problem of reducing the charge/discharge cycle performance. Since the hydrogen absorbing alloy powder is immersed in a hot alkali hydroxide solution to raise the activeness of the hydrogen absorbing alloy powder, a high output level can be achieved if the average particle size is not less than 10 μm or even not less than 20 μm. Thus, for the purpose of the present invention, the average particle size of the hydrogen absorbing alloy powder is preferably between 20 and 50 μm, more preferably between 20 and 35 μm.

The expression of average particle size as used herein refers to the cumulative average diameter (d 50) that is the value obtained by determining the cumulative curve, taking the entire volume of the powder sample as 100%, and getting the point where the cumulative curve shows the value of 50%.

### (Negative Electrode: Hydrogen Absorbing Electrode)

The negative electrode of a nickel metal-hydride battery according to the present invention is prepared by applying a negative electrode active material paste containing hydrogen absorbing alloy powder, a thickener, a binding agent and water as principal ingredients onto a support (to be also referred to as substrate), drying the paste, subsequently subjecting it to a rolling process to make the substrate and the paste show a predetermined thickness and then cutting them to the predetermined dimensions. Usually, the thickener may include a polysaccharide or a mixture of two or more than two polysaccharide selected from carboxymethylcellulose (CMC), methylcellulose (MC), and so on. The rate at which such a thickener is added is preferably 0.1 to 3 wt % relative to the total weight of the positive electrode or the negative electrode. The binding agents may generally include one, or two or more in combination selected from thermoplastic resins such as polytetrafluoroethylene (PTFE), polyethylene, polypropylene and polymers showing a rubber-like elasticity such as ethylene-propylene-dienterpolymer (EPDM), sulfonated EPDM, styrenebutadiene rubber (SBR), fluorine rubber and so on. The rate at which such a binding agent is added is preferably 0.1 to 3 wt % relative to the total weight of the negative electrode.

Additionally, one or more than one oxides or one or more than one hydroxides of yttrium (Y), ytterbium (Yb), erbium (Er), gadolinium (Gd) and/or cerium (Ce) may be added to and mixed with the negative electrode active material paste as anti-corrosion additive. Alternatively, the hydrogen absorbing alloy may be made to contain one or more than one of the above-listed elements in advance.

The corrosion, if any, of the hydrogen absorbing alloy powder is suppressed and an excellent cycle performance is obtained particularly when one or more than one oxides or one or more than one hydroxides of Er and/or Yb are added to and mixed with the hydrogen absorbing alloy powder. It may be safe to assume that an oxide or a hydroxide of Er or Yb reacts with the alkaline electrolyte in the battery to generate a hydroxide as a reaction product, which operates as anti-corrosion agent. The oxide or hydroxide of Er and/or Yb to be added preferably has an average particle size of not greater than 5 μm to achieve a high anti-corrosive effect probably because such an oxide or hydroxide is dispersed well and can easily react with the alkaline electrolyte.

The rate at which such an anti-corrosion additive is added is preferably 0.3 to 1.5 weight portions relative to 100 portions of hydrogen absorbing alloy powder. The anti-corrosive effect is not satisfactory when the rate of addition is less than 0.3 weight portions, whereas the anti-corrosive effect that can be obtained by adding an anti-corrosion additive by more than 1.5 weight portions is equivalent to the effect that can be obtained by adding an anti-corrosion additive by not more than 1.5 weight portions and such a high rate of adding an anti-corrosion additive can increase the reaction resistance of the hydrogen absorbing electrode.

When necessary, an electric conductor normally selected from natural graphite (scale-like graphite, clay-like graphite), artificial graphite, carbon black, acetylene black, ketchen black, carbon whisker, carbon fiber, gas phase developed carbon, metal (copper, nickel, gold and so on) powder, metal fiber and so on or a filler normally selected from olefin polymers such as polypropylene, polyethylene and so on and carbon powder may be added.

Any electron conductor may be used for the collector of the hydrogen absorbing electrode so long as it does not adversely affect the prepared battery. Examples of collector that can be used for the purpose of the present invention include nickel plates and nickel-plated steel plates as well as foam, molded bundle of fibers, three-dimensional substrates formed to convexo-concave, and two-dimensional substrates such as punched steel plates that are highly anti-reductive and anti-oxidative. Of such collectors, a punched plate (punched object) formed by plating an iron foil with Ni is suitable for the collector of the negative electrode because such an object is less costly and excellently conductive. While the thickness of the current collector is not subjected to any particular limitations, a collector having a thickness of 5 to 700 μm may preferably be used. The diameter of the holes produced by punching of the punched plate is preferably not greater than 1.7 mm and the aperture ratio thereof is preferably not less than 40%. With such an arrangement, the negative electrode active material and the current collector excellently adhere to each other with the use of a small amount of binding agent.

### (Positive Electrode: Nickel Electrode)

The positive electrode active material of a sealed nickel metal-hydride battery according to the present invention is a mixture prepared by adding zinc hydroxide and/or cobalt hydroxide to nickel hydroxide. A nickel hydroxide-composite hydroxide where zinc hydroxide and/or cobalt hydroxide is uniformly dispersed (solid-solubilized) in nickel hydroxide by co-precipitation is preferable.

Cobalt hydroxide and/or cobalt oxide is added to the positive electrode active material as electric conducting auxiliary agent. More specifically, nickel hydroxide-composite hydroxide coated with cobalt hydroxide or nickel hydroxide-composite oxide partly oxidized by oxygen, oxygen-containing gas or a oxidizing agent such as K₂S₂O₈ or hypochlorous acid may preferably be used. The average oxidation number of Ni and Co contained in the positive electrode active material is preferably set to 2.04 to 2.40 by controlling the rate of addition of the oxidizing agent.

One or more than one oxides or one or more than one hydroxides of one or more than one rare earth elements such as Y and Yb may further be added to the positive electrode in order to improve the oxygen overvoltage. It is advantageous that the average particle size of the powder of the positive electrode active material is small in order to obtain a high output. For the purpose of the present invention, the average particle size of the powder of the positive electrode active material is preferably not more than 50 μm, more preferably not more than 30 μm. However, the average particle size of the active material powder is preferably not less than 5 μm to prevent the filing density (g/cm³) of the active material from falling because the filling density can fall when the average particle size is excessively small.

A crusher or a classifier is employed to obtain hydrogen absorbing alloy powder with predetermined particle profiles. Examples of such machine include a mortar, a ball mill, a sand mill, a vibrating ball mill, a satellite ball mill, a jet mill, a counter jet mill, a swirling air flow type jet mill and a sieve. A technique of wet crushing can also be employed by using an aqueous solution containing one or more than one alkali metals for crushing. While the classification process of the present invention is not subjected to any particular limitations, a sieve or a wind power classifier can be used depending on if the classification process is a wet process or dry process.

While any electric conductor may be used without limitations so long as it is made of an electron conducting material and does not adversely affect the performance of the battery, an electric conducting material normally selected from natural graphite (scale-like graphite, clay-like graphite), artificial graphite, carbon black, acetylene black, ketchen black, carbon whisker, carbon fiber, gas phase developed carbon, metal (copper, nickel, gold and so on) powder, metal fiber and so on or a mixture of more than one of them may preferably be used for the purpose of the present invention.

Of the above listed substances, acetylene black is preferable from the viewpoint of conductivity and coating. The rate at which the electric conductor is added is preferably 1 to 10 wt % relative to the total weight of the positive electrode or negative electrode. Acetylene black crushed to ultra-fine particles of 0.1 to 0.5 μm is particularly preferable from the viewpoint of reducing the required quantity of carbon. The selected materials are physically and ideally uniformly mixed. Mixing machines that can be used for mixing include dry and wet powder mixers such as a V-type mixer, an S-type mixer, a grinder/mixer, a ball mill and a satellite ball mill.

As in the case of the negative electrode, binding agents that can be used for the purpose of the present invention generally include one, or two or more in combination selected from thermoplastic resins such as polytetrafluoroethylene (PTFE), polyethylene, polypropylene and so on and polymers showing a rubber-like elasticity such as ethylene-propylene-dienterpolymer (EPDM), sulfonated EPDM, styrenebutadiene rubber (SBR), fluorine rubber and so on. The rate at which such a binding agent is added is preferably 0.1 to 3 wt % relative to the total weight of the positive electrode or the negative electrode.

Thickeners that can be used for the purpose of the present invention generally include a polysaccharide or a mixture of two or more than two polysaccharide selected from carboxymethylcellulose (CMC), methylcellulose (MC), hydroxypropylmethylcellulose (HPMC), xanthan gum, weran gum and so on, of which xanthan gum and weran gam are preferable materials as thickeners to be used for the positive electrode active material paste because they are excellently anti-acidic. The rate at which such a thickener is added is preferably 0.1 to 3 wt % relative to the total weight of the positive electrode or the negative electrode.

Any filler can be used for the purpose of the present invention so long as it does not adversely affect the performance of the battery. Fillers that can be used for the purpose of the present invention generally include olefin polymers such as polypropylene, polyethylene and so on, carbon and so on. The rate at which such a filler is added is preferably not more than 5 wt % relative to the total weight of the positive electrode or the negative electrode

Both the positive electrode and the negative electrode can be prepared appropriately by mixing the active material, the electric conductor and the binding agent with water and an organic solvent such as alcohol, toluene or the like, subsequently applying the obtained mixture solution to a current conductor, which will be described in greater detail hereinafter, and drying the mixture solution. Methods of application that can be used for applying the mixture solution include roller coating by means of an applicator roll, screen coating, the use of a doctor blade, spin coating, and the use of a bar coater in order to make the applied layer show a desired thickness and a desired profile, although the methods that can be used for the purpose of the present invention are not limited to the above cited ones.

Any electron conductor may be used for the nickel electrode collector so long as it does not adversely affect the prepared battery. Examples of collector that can be used for the purpose of the present invention include nickel plates and nickel-plated steel plates that are highly anti-reductive and anti-acidic as well as foam, molded bundle of fibers, three-dimensional substrates formed to convexo-concave and two-dimensional substrates such as punched steel plates. Of these, a foam made of Ni that is highly porous and excellent in terms of active material powder holding function may preferably be used for the purpose of the present invention. While the thickness of the current collector is not subjected to any particular limitations, a current collector having a thickness of 5 to 700 μm may preferably be used.

In addition to baked carbon and an electro-conductive polymer, an object obtained by causing Ni powder, carbon or platinum to adhere to the surface of the nickel of the collector for treatment may be used for the purpose of improving the adhesiveness, the electro-conductivity and the anti-acidic effect. The surface of such a material can be subjected to an oxidizing process.

As for the separator of a nickel metal-hydride battery according to the present invention, porous membrane, non-woven fabric or a combination of them may be used for the separator because those materials show an excellent high-rate performance. The material of porous membrane or non-woven fabric can be selected from polyolefin resins such as polyethylene and polypropylene and nylon.

The porosity of the separator is preferably not higher than 80 vol % from the viewpoint of securing a sufficient strength of the separator, preventing internal short-circuiting due to the electrode running through the separator and securing a sufficient gas permeability of the separator. On the other hand, the porosity of the separator is preferably not less than 20 vol % from the viewpoint of reducing the electric resistance of the separator and securing an excellent high-rate performance. The separator is preferably subjected to a treatment for improving the hydrophilicity thereof. For example, a separator that is made of polyolefin resins such as polyethylene and whose surface is subjected to a sulfonation treatment, a corona treatment and/or a PVA treatment may be used. Alternatively, a mixture containing a resin material subjected to such a treatment may be used for the separator.

Any electrolyte proposed for use in alkali batteries may be used for the purpose of the present invention. Water may be employed as solvent for the electrolyte and a solute that is potassium, sodium or lithium or a mixture of two or more than two of them may be used as solute for the electrolyte, although the present invention by no means limited thereto. A preferable example of electrolyte for preparing a battery showing excellent battery characteristics is a solution containing potassium hydroxide by 5 to 7 mol/dm³ and lithium hydroxide by 0.1 to 0.8 mol/dm³ as electrolytic salts.

Additionally, an anti-corrosion agent, an additive for increasing the oxygen overvoltage of the positive electrode and/or an additive for suppressing the self discharge may be added to the electrolyte for the hydrogen absorbing alloy powder. Specific examples of such additives include Y, Yb, Er, calcium (Ca), sulfur (S), zinc (Zn) and/or a mixture of two of them, although the present invention is by no means limited thereto.

A nickel metal-hydride battery according to the present invention is suitably prepared typically by injecting an electrolyte before or after stacking a positive electrode, a separator and a negative electrode as so many layers and ultimately sealing the battery by means of a coat material. In the case of a nickel metal-hydride battery prepared by winding the generating elements formed by stacking a positive electrode, a negative electrode and a separator as so many layers, an electrolyte is preferably injected into the generating elements before and after winding them. While the electrolyte can be injected under atmospheric pressure, vacuum impregnation, pressure impregnation or centrifugal impregnation may alternatively be used.

Coat materials that can be used for a nickel metal-hydride battery according to the present invention include nickel-plated iron, stainless steel and polyolefin resin.

The structure of a nickel metal-hydride battery according to the present invention is not subjected to any particular limitations. However, a battery having a rolled electrode assembly formed by winding a positive electrode, a negative electrode and a separator into a roll is preferable because it has a minimum number of electrode plates and the area of its electrodes is maximized.

### (Collecting Structure)

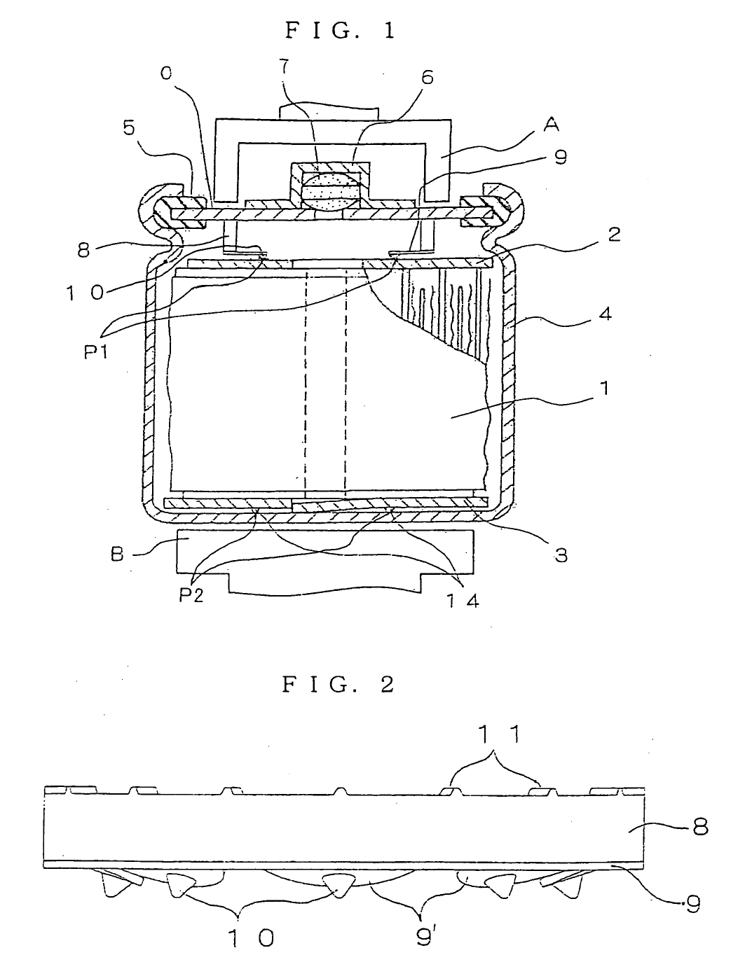

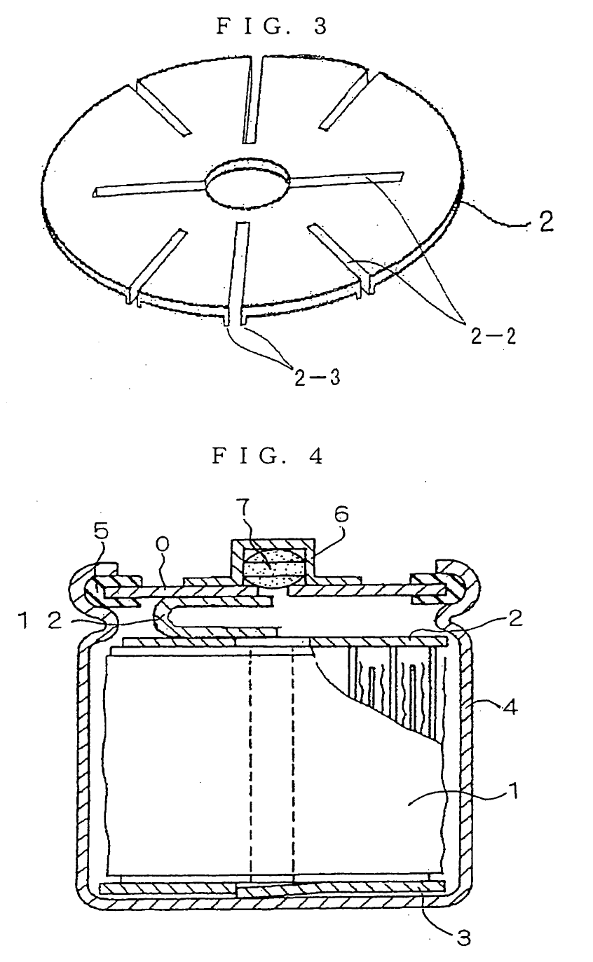

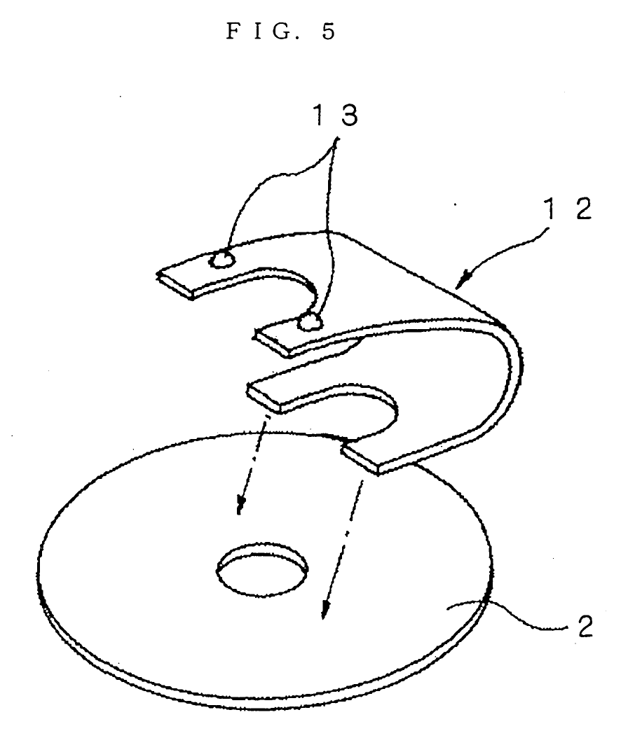

FIG. 1 is a schematic cross-sectional view of the structure of a nickel metal-hydride battery according to the present invention. Referring to FIG. 1, a rolled electrode assembly 1 is contained in a bottomed cylindrical container 4 and the open end of the container 4 is sealed by a lid. The lid includes a sealing plate 0, a gasket 5 being mounted at the peripheral edge of the sealing plate 0, a cap 6 bonded to the outer surface of the sealing plate 0 and a valve 7 arranged in the space defined by the cap 6 and the sealing plate 9. The inner surface of the sealing plate 0 and the upper surface of the upper current collecting plate 2 fitted to the upper rolled end of the electrode assembly 1 is connected to each other by means of a current collecting lead.

FIG. 1 also schematically illustrates the method of welding at least either the sealing plate 0 and the current collecting lead at their welded points or the current collecting lead and the upper current collecting plate 2 at their welded points P1 (P1 being preferable as will be described hereinafter). Before welding at least either the sealing plate 0 and the current collecting lead at their welded points or the current collecting lead and the upper current collecting plate 2 at their welded point, the container 4 is bent along the open end thereof and the gasket fitted to the peripheral edge of the sealing plate 0 is caulked to seal the container. As the container is sealed, at least either the sealing plate 0 and the current collecting lead or the current collecting lead and the upper current collecting plate 2 contact each other at the unwelded welded points thereof. Then, under the sealed condition, the positive electrode terminal (lid) and the negative electrode terminal (container 4) of the battery are brought into contact with the output terminals A, B of an external power source (electric resistance welder) and a welding current is made to flow. As a result of the energization, the two members are welded at the welded points. Since a welding current is made to flow under the sealed condition with the above described method, the current collecting lead is not required to be provided with an extra curvature for the welding and hence the length of the lead connecting the sealing plate and the upper current collecting plate can be minimized to reduce the electric resistance of the lead if compared with the conventional art.

For the purpose of the present invention, the minimum length of the current collecting lead between the welded points of the inner surface of the sealing plate 0 and the current collecting lead and the welded points P1 of the current collecting lead and the upper current collecting plate 2 is preferably made to not larger than 2.1 times the gap between the sealing plate 0 and the upper current collecting plate 2, more preferably not larger than 1.7 times.

FIG. 2 is a schematic illustration of an example of collecting lead that can be used for a nickel metal-hydride battery according to the present invention. A ring-shaped current collecting lead can be used for the purpose of the present invention because the current collecting lead is not required to have an extra curvature for the welding. The ring-shaped current collecting lead typically has a height of 0.4 to 1 mm and can be produced by cutting a nickel-made pipe or by winding a nickel plate. The ring is not limited to a single ring and may be a double ring formed by folding a metal plate and winding it into a ring or by bending or squeezing a metal plate. However, from the viewpoint of mass production, the current collecting lead is preferably provided with the function of a spring that absorbs the variances in the gap between the inner surface of the sealing plate 0 and the upper surface of the collecting plate 2 because a simple ring-shaped collecting lead cannot absorb such variances and the current collecting lead and the upper current collecting plate can be welded defectively due to the variances.

In the instance of FIG. 2, a supplementary lead 9 having a plurality of jutted chips 9′ is bonded to one of the ends (lower end in FIG. 2) of the ring-shaped main lead 8. The supplementary lead is prepared by processing a metal plate, which may typically a 0.2 to 0.5 mm-thick nickel plate and made to extend obliquely downwardly from the lower end of the ring-shaped main lead as shown in FIG. 2. As the jutted chips 9′ of the supplementary lead 9 are provided with such projections, the supplementary lead 9 is made to function as a spring so that, if the distance of the gap separating the inner surface of the sealing plate 0 and the upper surface of the upper current collecting plate 2 has variances, the current collecting lead (the projections 10 at the front ends of the jutted chips 9′) and the upper current collecting plate 2 are brought into good contact with each other due to the function of the supplementary lead 9 as a spring and welded satisfactorily.

As shown in FIG. 2, one of the ends (the upper end in FIG. 2) of the ring-shaped main lead 8 is provided with projections 11 for the purpose of facilitating the operation of welding the main lead 8 and the sealing plate 0. Additionally, the supplementary lead 9 is provided at the front ends of the jutted chips 9′ with respective projections 10 for the purpose of facilitating the operation of welding to the upper current collecting plate. Normally, the upper current collecting plate has a thickness smaller than the sealing plate so that it will be welded to the current collecting lead satisfactorily with a small quantity of heat. Therefore, according to the present invention, it is preferable that the current collecting lead (the ring-shaped main lead 8 in the instance of FIG. 2) is welded to the inner surface of the sealing plate 0 in advance before sealing the battery and the current collecting lead (supplementary lead 9) and the upper current collecting plate 2 are welded after sealing the battery by causing a welding current to flow and energizing them. The projections 11 arranged at the current collecting lead (the ring-shaped main lead 8 in FIG. 2) are mostly molten and disappear when the sealing plate and the current collecting lead are welded to each other before sealing the battery. FIG. 1 shows a state where the sealing plate 0 and the main lead 8 are welded prior to sealing the battery and the projection 11 arranged at the main lead have disappeared.

For the purpose of the present invention, the ratio of the distance from the welded points P1 (FIG. 1) of the current collecting lead (supplementary lead 9) and the upper current collecting plate 2 to the center of the upper current collecting plate to the radius of the electrode assembly 1 is preferably between 0.4 and 0.7 since such a ratio provides an excellent output power performance because the welded points are then found in a central part of the long edges of the electrode plates to probably enhance the current collecting function. The number of welded points P1 is between 2 and 16, preferably between 4 and 16, because the collecting resistance can be suppressed to a low level when such a number is used, although the number of welded points P1 may vary depending on the size of the battery.

FIG. 3 is a schematic perspective view of an example of upper current collecting plate 2 that can be used for the purpose of the present invention. The upper current collecting plate 2 is typically made of a nickel plate or a nickel-plated steel plate having a thickness of 0.3 to 0.5 mm. As shown in FIG. 3, the upper current collecting plate 2 is disk-shaped and has a central through hole and a plurality of radial slits 2-2 extending from the center toward the peripheral edge thereof. The slits 2-2 can effectively reduce the idle current that arises when bonding the upper current collecting plate to the electrode (e.g. the positive electrode) projecting from the corresponding rolled end of the electrode assembly by electric resistance welding. The upper current collecting plate and the projecting electrode can be bonded well by bending the opposite edges of the slits 2-2 to form brackets 2-3 having a height between 0.2 and 0.5 mm and extending downward from the opposite edges of the slits because the brackets 2-3 are engaged with the corresponding long edge of the electrode.

For the purpose of the present invention, the lower current collecting plate 3 is preferably fitted to the other rolled end (the lower end in FIG. 1) of the electrode assembly 1. More specifically, the corresponding long edge of the other electrode (e.g., the negative electrode) is made to project from the other rolled end of the electrode assembly 1 and bonded to the lower current collecting plate 3. Like the upper current collecting plate 2, the lower current collecting plate 3 is typically made of a nickel plate or a nickel-plated steel plate having a thickness of 0.3 to 0.5 mm and preferably has a plurality of radial slits extending from the center toward the peripheral edge thereof, each of the slits being provided with a pair of brackets extending from the edges thereof.

For the purpose of the present invention, the lower current collecting plate is preferably provided with a plurality of projections 14 located at positions other than the center thereof and a plurality of welded points to be welded to the inner surface of the bottom of the container 4 that are also located at positions other than the center thereof (welded point P2 in FIG. 1). The ratio of the distance from the welded points P2 to the center of the upper current collecting plate to the radius of the electrode assembly 1 is preferably between 0.5 and 0.8 since such a ratio provides an excellent output power performance because the welded points are then found in a central part of the long edges of the electrode plates to probably enhance the current collecting function. The number of welded points P2 is between 2 and 16, preferably between 4 and 16, because the current collecting resistance can be suppressed to a low level when such a number is used, although the number of welded points P2 may vary depending on the size of the battery.

### EXAMPLES

Now, the present invention will be described further by way of examples, although the present invention is by no means limited by the examples. The test method, the material of the positive electrode and that of the negative electrode as well as the positive electrode, the negative electrode, the electrolyte, the separator and the profile of the battery may be appropriately selected.

### (Preparation of Hydrogen Absorbing Alloy Powder)

Mms including La, Ce, Pr and Nd were used as rare earth elements. Four elements of Ni, Co, Al and Mn were selected as non-rare earth elements. The component elements were weighed so as to obtain thirteen hydrogen absorbing alloys having the respective compositions a through m as shown in Table 1. Then, they were heated and molten in an Ar atmosphere and subsequently quickly cooled and solidified by melt-spinning. Thereafter, they were heated at 900° C. in an Ar atmosphere for annealing. The obtained hydrogen absorbing alloys were crushed to produce hydrogen absorbing alloy powders showing an average particle size of 20 μm. The Mm ratios shown in Table 1 are weight ratios (wt %) of the elements relative to 100 wt % of the entire Mm. The component ratios of the non-rare earth metal elements shown in Table 1 are ratios of the mole numbers (mole ratios) of the metal elements relative to the total mole number of the rare earth elements of the Mm.

Table 1 shows the compositions of the prepared hydrogen absorbing alloy powders, B/A, and the equilibrium hydrogen dissociation pressures at 40° C. and H/M=0.5.

TABLE 1

| | | | equilibrium |
|---|---|---|---|
| classification of | | | hydrogen |
| hydrogen | | | dissociation |
| absorbing alloy | alloy composition | B/A | pressure (MPa) |
| a | Mm(La₈₀Ce₁₄Pr₂Nd₄)Ni_{4.00}Co_{0.55}Al_{0.35}Mn_{0.30} | 5.20 | 0.02 |
| b | Mm(La₇₀Ce₂₂Pr₂Nd₆)Ni_{4.00}Co_{0.55}Al_{0.35}Mn_{0.30} | 5.20 | 0.04 |
| c | Mm(La₆₃Ce₂₇Pr₂Nd₈)Ni_{4.00}Co_{0.55}Al_{0.35}Mn_{0.30} | 5.20 | 0.06 |
| d | Mm(La₇₀Ce₂₂Pr₂Nd₆)Ni_{4.00}Co_{0.55}Al_{0.29}Mn_{0.30} | 5.20 | 0.07 |
| e | Mm(La₅₇Ce₃₃Pr₂Nd₈)Ni_{4.00}Co_{0.55}Al_{0.35}Mn_{0.30} | 5.20 | 0.08 |
| f | Mm(La₅₀Ce₃₆Pr₃Nd₁₁)Ni_{4.00}Co_{0.55}Al_{0.35}Mn_{0.30} | 5.20 | 0.10 |
| g | Mm(La₆₃Ce₂₇Pr₂Nd₈)Ni_{4.10}Co_{0.55}Al_{0.25}Mn_{0.30} | 5.20 | 0.12 |
| h | Mm(La₅₅Ce₃₁Pr₃Nd₁₁)Ni_{4.10}Co_{0.55}Al_{0.25}Mn_{0.30} | 5.20 | 0.14 |
| i | Mm(La₇₀Ce₂₂Pr₂Nd₆)Ni_{4.00}Co_{0.55}Al_{0.25}Mn_{0.30} | 5.05 | 0.07 |
| j | Mm(La₇₀Ce₂₂Pr₂Nd₆)Ni_{4.02}Co_{0.55}Al_{0.23}Mn_{0.30} | 5.10 | 0.07 |
| k | Mm(La₇₀Ce₂₂Pr₂Nd₆)Ni_{4.06}Co_{0.55}Al_{0.24}Mn_{0.30} | 5.15 | 0.07 |
| l | Mm(La₇₀Ce₂₂Pr₂Nd₆)Ni_{4.06}Co_{0.55}Al_{0.34}Mn_{0.30} | 5.25 | 0.07 |
| m | Mm(La₇₀Ce₂₂Pr₂Nd₆)Ni_{4.10}Co_{0.55}Al_{0.35}Mn_{0.30} | 5.30 | 0.07 |

### Examples 1 through 5

### Comparative Examples 1 and 2

### Preparation of Positive Electrode)

An amine complex was produced by adding ammonium sulfate and an aqueous NaOH solution to an aqueous solution produced by dissolving nickel sulfate, zinc sulfate and cobalt sulfate at a predetermined ratio. Additionally, an aqueous NaOH solution was dropped into the solution, while stirring the latter fiercely, to synthesize spherical high density nickel hydroxide particles that operate as core layer parent material and show a ratio of nickel hydroxide:zinc hydroxide:cobalt hydroxide=88.45:5.12:1.1 by controlling the pH of the reaction system to 11 to 12.

The obtained high density nickel hydroxide particles were dropped into an alkaline aqueous solution whose pH was controlled to 11 to 12 by means of an aqueous NaOH solution. Then, an aqueous solution containing cobalt sulfate and ammonium sulfate to predetermined concentrations was dropped, while stirring the solution. During the operation, an aqueous NaOH solution was dropped appropriately to maintain the pH of the reaction bath to the range from 11 to 12. The pH was held to the range from 11 to 12 for about an hour to form a surface layer of a hydroxide mixture containing Co on the surfaces of the nickel hydroxide particles. The ratio of the surface layer of the hydroxide mixture relative to the core layer parent particles (to be simply referred to as core layer hereinafter) was 4.0 wt %. 50 g of nickel hydroxide particles having a surface layer of the hydroxide mixture was put into an aqueous NaOH solution of 30 wt % (10N) at 110° C. and the mixture was thoroughly stirred. Subsequently, K₂S₂O₈ was added at an excessive rate relative to the equivalent of the cobalt hydroxide contained in the surface layer to confirm that oxygen gas was generated from the surfaces of the particles. The obtained particles were filtered, washed with water and dried to produce powder of an active material.

An aqueous solution of carboxymethylcellulose (CMC) was added to mixture powder of the above active material powder and Yb(OH)₃ powder showing an average particle size of 6 μm to produce a pasty material showing a weight ratio of the active material powder:Yb(OH)₃ powder:CMC (solid ingredient)=100:2:0.5. The paste was filled into a nickel porous body of 450 g/m² (Nickel Cellmet #8 tradename, available from Sumitomo Electric Industries) Then, the porous body filled with the paste was dried at 80° C. and pressed to show a predetermined thickness. Thus, a nickel positive electrode plate having a width of 48.5 mm, a length of 1,100 mm and a capacity of 6,500 mAh (6.5 Ah) and provided with an active material-free zone having a width of 1.5 mm and extending along one of the long sides of the plate was obtained.

### (Process of Immersing Hydrogen Absorbing Alloy Powder in Alkaline Aqueous Solution)

Each of the hydrogen absorbing alloy powders of b, c, e, f, g, a and h shown in Table 1 and having an average particle size of 20 μm was immersed in an aqueous NaOH solution showing a concentration of 48 wt % at 100° C. for 3 hours. During this process, the stirrer tank is stirred and hydrogen absorbing alloy powders were dispersed in the tank. Subsequently, the solution was filtered under pressure to separate the treatment solution from the alloy. Then, pure water was added by the weight equal to the weight of the alloy and the mixture was subjected to ultrasonic of 28 KHz for 10 minutes. Then, while being stirred gently, pure water was injected from a lower part of an stirrer tank and flown from an upper part thereof. Pure water was made to flow through the stirrer tank in this way to remove free rare earth oxides from the alloy powder. Thereafter, the alloy powder was washed with water until the pH value falls below 10 and filtered under pressure. Then, the alloy powder was exposed to hot water at 80° C. to eliminate hydrogen. The hot water was filtered under pressure and the alloy powder was once again washed with water and cooled to 25° C. Then, 4% hydrogen peroxide was added by the weight same as that of the alloy, while stirring the mixture, to eliminate hydrogen and obtain hydrogen absorbing alloy for an electrode. All the saturation mass susceptibilities of the obtained hydrogen absorbing alloy powders b, c, e, f, g, a and h were 4.5 emu/g.

### (Preparation of Negative Electrode Plate)

More specifically, 1 weight portion of Er₂O₃ showing an average particle size of 5 μm, 0.65 weight portions of styrenebutadiene copolymer (SBR), 0.3 weight portions of hydroxypropyl methylcellulose (HPMC) and a predetermined quantity of water were added to 100 portions of hydrogen absorbing alloy powder and the mixture was kneaded to produce paste of the mixture. Then, the paste was applied to a negative electrode substrate of a punched and nickel-plated steel plate and subsequently dried at 80° C. Then, the electrode plate was pressed to make the electrode plate of the obtained negative electrode (hydrogen absorbing electrode) show a predetermined height, a width of 48.5 mm, a length of 1,180 mm and a capacity of 11,000 mAh (11.0 Ah) with an active material-free zone having a width of 1.5 mm and extending along one of the long sides of the plate. The rate of filling hydrogen absorbing alloy powder of the negative electrode per 1 cm² was 0.07 g.

### (Preparation of Rolled Electrode Assembly)

The negative electrode plate, a 120 μm-thick unwoven fabric separator of sulfonated polypropylene and the positive electrode plate were laid one on the other to form a multilayer structure. The multilayer structure was then wound to a roll to produce an electrode assembly having a radius of 15.2 mm.

### (Fitting Current Collecting Plates)

A 0.3 mm-thick disk-shaped upper current collecting plate (positive electrode current collecting plate) 2 that was a nickel-plated steel plate having a radius of 14.5 mm and provided with a central through hole and eight slits 2-2 radially extending from the center to the peripheral edge, a pair of 0.5 mm-high brackets (parts to be engaged with the corresponding electrode substrate) being extending downward from the opposite edges of each of the slits, was bonded to the end of the positive electrode substrate projecting at one of the rolled ends of the electrode assembly by resistance welding. The center of the upper current collecting plate was aligned with the center of the rolled end of the electrode assembly.

Similarly, a 0.5 mm-thick disk-shaped lower current collecting plate (negative electrode current collecting plate) that was a nickel-plated steel plate having a radius of 14.5 mm and provided with a central through hole and eight slits 2-2 extending from the center to the peripheral edge, a pair of 0.5 mm-high brackets (parts to be engaged with the corresponding electrode substrate) being extending upward from the opposite edges of each of the slits, was bonded to the end of the negative electrode substrate projecting at the other rolled ends of the electrode assembly by resistance welding. The center of the lower current collecting plate was aligned with the center of the rolled end of the electrode assembly. A total of nine projections 14 including a central projection and eight surrounding projections were arranged on the lower current collecting plate. The eight surrounding projections were arranged respectively in eight sections separated by the slits. The eight surrounding spot projections other than the central projection were separated from the center of the lower current collecting plate (aligned with the center of the corresponding rolled end of the electrode assembly) by 10.6 mm, (the ratio of the distance to the radius of the electrode assembly being 0.7). The central projection of the lower current collecting plate was made slightly lower than the other eight projections.

### (Welding of Lower Current Collecting Plate and Bottom Inner Surface of Container)

A cylindrical container with a bottom made of nickel-plated steel plates was brought in and the electrode assembly, to which the upper current collecting plate and the lower current collecting plate had been fitted, was contained in the container such that the upper current collecting plate was located at the open end of the container while the lower current collecting plate was held in contact with the bottom of the container. Then, after the upper current collecting plate was prevented from contacting with the container by an insulator, a channel was formed on the container and an aqueous electrolyte containing KOH by 6.8 mol/dm³ and LiOH by 0.8 mol/dm³ was injected by a predetermined quantity.

After the injection, the welding output terminals of a resistance welder were brought into contact respectively with the positive electrode current collecting plate and the bottom surface (negative electrode terminal) of the container and electrically energized so as to show the same current value and the same energization period both in the charge direction and in the discharge direction. More specifically, the current value was set to be 0.6 kA/Ah (6.0 kA) per 1 Ah of the capacity (6.5 Ah) of the positive electrode plate while the energization period was set to be 4.5 msec both in the charge direction and in the discharge direction and 2 cycles of an AC pulse current was set to be applied. As a result of the application of an AC pulse current of a square wave, the lower surface of the lower current collecting plate and the inner surface of the bottom of the container were welded to each other at the eight projections. Subsequently, the electrode bar for resistance welding was pressed against the upper surface of the lower current collecting plate and the outer surface of the bottom of the container by a circular central through hole formed on the center of the electrode assembly in order to bring the projection at the center of the lower surface of the lower current collecting plate into tight contact with the inner surface of the bottom of the container and the projection was welded to the inner surface of the bottom of the container by electric resistance welding.

### (Welding Current Collecting Lead and Inner Surface of Lid)

A ring-shaped main lead that was made of a 0.8 mm-thick nickel plate with a width of 2.5 mm and a length of 66 mm and provided along one of the long sides thereof with sixteen 0.2 mm-high projections also along the other long side thereof with sixteen 0.2 mm-high projections and wound to a ring and an supplementary lead that was made of a 0.3 mm-thick nickel plate and had a ring-shaped part having an outer diameter same as the main lead, eight jutted chips projecting toward the inside of the ring-shaped part by 1 mm and projections projecting from the front ends of the respective jutted chips were prepared.

A lid made of a nickel-plated steel plate and having a circular central through hole of a diameter of 0.3 mm was prepared and the sixteen 0.2 mm-high projections of the main lead were brought into contact with the inner surface of the lid. Then, the ring-shaped main lead was welded to the inner surface of the lid by electric resistance welding. Subsequently, the supplementary lead was bonded to the ring-shaped main lead. A valve (exhaust valve) and a cap-shaped terminal were fitted to the outer surface of the lid to produce a lid. A ring-shaped gasket was fitted to the lid so as to surround the peripheral edge of the lid. The lid had a radius of 14.5 mm and the cap had a radius of 6.5, while the caulked radius of the gasket was 12.5 mm.

### (Sealing and Shaping)

The lid to which the current collecting lead was fitted was then placed on the electrode assembly such that the supplementary lead was held in contact with the flat part of the upper current collecting plate and the open end of the container was caulked to airtightly seal the battery. Then, the total height of the battery was adjusted by compressing it.

### (Welding of Supplementary Lead and Upper Current Collecting Plate)

The output terminals A and B of the electric resistance welder was held in contact respectively with the lid (positive electrode terminal) and the bottom surface (negative electrode terminal) of the container 4 and the energization conditions were so set as to show a same current value and a same energization period both in the charge direction and in the discharge direction. More specifically, the current value was set to be 0.6 kA/Ah (6.0 kA) per 1 Ah of the capacity (6.5 Ah) of the positive electrode plate while the energization period was set to be 4.5 msec both in the charge direction and in the discharge direction and 2 cycles of an AC pulse current composed of rectangular waves was set to be applied through the inside of the battery. At this time, it was confirmed that gas was not being generated to exceed the valve-opening pressure. The lid and the upper current collecting plate (positive current electrode collecting plate) were welded to each other to connect the lid and the positive electrode collecting plate at the ring-shaped main lead by way of the supplementary lead and produce a sealed nickel metal-hydride battery as shown in FIG. 1.

The shortest distance between the welded points of the inner surface of the sealing plate and the main lead and the welded points of the upper current collecting plate and the supplementary lead was 1.4 times as long as the gap separating the sealing plate and the upper current collecting plate. The ratio of the distance separating the welded points of the current collecting lead and the eight welded points of the upper current collecting plate and the center of the upper current collecting plate to the radius of the electrode assembly was 0.6.

The hydrogen absorbing alloy powders b, c, e, f, g, a and h were used in respective examples, which are referred to as Examples 1 through 5 and Comparative Examples 1 and 2. Each of all the batteries of Examples 1 through 5 and Comparative Examples 1 and 2 weighed 172 g.

### (Chemical Conversion)

After leaving each of the sealed nickel metal-hydride batteries of Examples 1 through 5 and Comparative Examples 1 and 2 at ambient temperature of 25° C. for 12 hours, the battery was charged at 130 mA (0.02 ItA) for 1,200 mAh and subsequently at 650 mA (0.1 ItA) for 10 hours before it was discharged at 1,300 mA (0.2 ItA) down to the cut voltage of 1 V. Thereafter, the battery was charged at 650 mA (0.1 ItA) for 16 hours before it was discharged at 1,300 mA (0.2 ItA) down to the cut voltage of 1.0 V and the charge/discharge cycle was repeated four times. Additionally, a cycle of charging the battery at 6.500 mA (1 ItA) at 45° C. until −ΔV shows fluctuations of 5 mV and discharging the battery at 6,500 mA (1 ItA) down to 1.0 V was repeated ten times.

### (Measurement of Output Density)

A single battery that had been subjected to chemical conversion was used to measure the output density in an atmosphere of 25° C. More specifically, the battery was charged at 650 mA (0.1 ItA) in an atmosphere of 25° C. for 5 hours after the end of discharge and then left in an atmosphere of 0° C. for 4 hours. Subsequently, the battery was discharged with a discharge current of 30 A (which corresponds to 4.6 ItA) for 12 seconds and the voltage at the tenth second after the start of the discharge was defined as the 10th second voltage in a 30 A discharge operation. Then, the battery was charged with the quantity of electricity equal to the discharged quantity of electricity by means of a charge current of 6 A. Thereafter, the battery was discharged with a discharge current of 40 A (which corresponds to 6.2 ItA) for 12 seconds and the voltage at the tenth second after the start of the discharge was defined as the 10th second voltage in a 40 A discharge operation. Similarly, the battery was discharged with a discharge current of 50 A (which corresponds to 7.7 ItA) for 12 seconds and the voltage at the tenth second after the start of the discharge was defined as the 10th second voltage in a 50 A discharge operation. Likewise, the battery was discharged with a discharge current of 60 A (which corresponds to 9.2 ItA) for 12 seconds and the voltage at the tenth second after the start of the discharge was defined as the 10th second voltage in a 60 A discharge operation. The 10th second voltages (measured values) were plotted relative to the discharge currents and linearly approximated by means of the method of least squares and the voltage value observed when the current value is extrapolated at 0 A was expressed as E0, while the inclination of the straight line was expressed as RDC. The value obtained by using E0, RDC and the battery weight as substitutes in the formula shown below was defined as output density at 0° C. when cut at 0.8 V.

output density (W/kg)=(E0−0.8)÷RDC×0.8/battery weight (kg)

### (Charge/Discharge Cycle Test)

A charge/discharge cycle test was conducted in an atmosphere of 45° C. The battery that had been subjected to chemical conversion was left in an atmosphere of 45° C. for 4 hours. Then, the battery was charged at a charge rate of 0.5 ItA until −ΔV shows fluctuations of 5 mV and discharged at a discharge rate of 0.5 ItA down to the discharge cut voltage of 1.0 V. The above charge/discharge cycle was repeated and the number of cycles observed when the discharge capacity became short of 80% of the discharge capacity of the first cycle of the charge/discharge cycle test was defined as cycle life.

### Examples 6 through 10

### Comparative Examples 3 and 4

### Process of Immersing Hydrogen Absorbing Alloy Powder in Alkaline Aqueous Solution)

Each of the hydrogen absorbing alloy powders b, c, e, f, g, a and h was immersed for 1.3 hours in an NaOH aqueous showing a concentration of 48 wt % at 100° C. All the saturation mass susceptibilities of the hydrogen absorbing alloy powders b, c, e, f, g, a and h were 2 emu/g.

### (Preparation and Test of Nickel Metal-Hydride Battery)

Batteries were prepared as in Examples 1 through 5 and Comparative Examples 1 and 2 except that a different duration of immersion in an alkaline aqueous solution was used for the hydrogen absorbing alloy powders and subjected to a similar test. The examples that employed the hydrogen absorbing alloy powders b, c, e, f, g, a and h are referred to respectively as Examples 6 through 10 and Comparative Examples 3 and 4.

### Comparative Examples 5 through 11

### Hydrogen Absorbing Alloy Powder)

The hydrogen absorbing alloy powders b, c, e, f, g, a and h were employed to prepare hydrogen absorbing electrodes without being immersed in an alkaline aqueous solution. All the saturation mass susceptibilities of the hydrogen absorbing alloy powders were 0.06 emu/g.

### (Preparation and Test of Nickel Metal-Hydride Battery)

Batteries were prepared as in Examples 1 through 5 and Comparative Examples 1 and 2 except that the hydrogen absorbing alloy powders were not immersed in an alkaline aqueous solution and subjected to a similar test. The examples that employed the hydrogen absorbing alloy powders b, c, e, f, g, a and h are referred to respectively as Comparative Examples 5 through 11.

Table 2 below shows the hydrogen absorbing alloy powders and the saturation mass susceptibility values of the Examples 1 through 10 and the Comparative Examples 1 through 11.

TABLE 2

| | hydrogen | saturation | | hydrogen | saturation | | hydrogen | saturation |
|---|---|---|---|---|---|---|---|---|
| | absorbing | mass | | absorbing | mass | | absorbing | mass |
| | alloy | susceptibility | | alloy | susceptibility | | alloy | susceptibility |
| classification | classification | (emu/g) | classification | classification | (emu/g) | classification | classification | (emu/g) |
| Example 1 | b | 4.5 | Example 6 | b | 2 | Comp. Ex. 5 | b | 0.06 |
| Example 2 | c | 4.5 | Example 7 | c | 2 | Comp. Ex. 6 | c | 0.06 |
| Example 3 | e | 4.5 | Example 8 | e | 2 | Comp. Ex. 7 | e | 0.06 |
| Example 4 | f | 4.5 | Example 9 | f | 2 | Comp. Ex. 8 | f | 0.06 |
| Example 5 | g | 4.5 | Example 10 | g | 2 | Comp. Ex. 9 | g | 0.06 |
| Comp. Ex. 1 | a | 4.5 | Comp. Ex. 3 | a | 2 | Comp. Ex. 10 | a | 0.06 |
| Comp. Ex. 2 | h | 4.5 | Comp. Ex. 4 | h | 2 | Comp. Ex. 11 | h | 0.06 |

### (Relationship Among Equilibrium Hydrogen Dissociation Pressure and Saturation Mass Susceptibility of Hydrogen Absorbing Alloy Powder and Output Density)

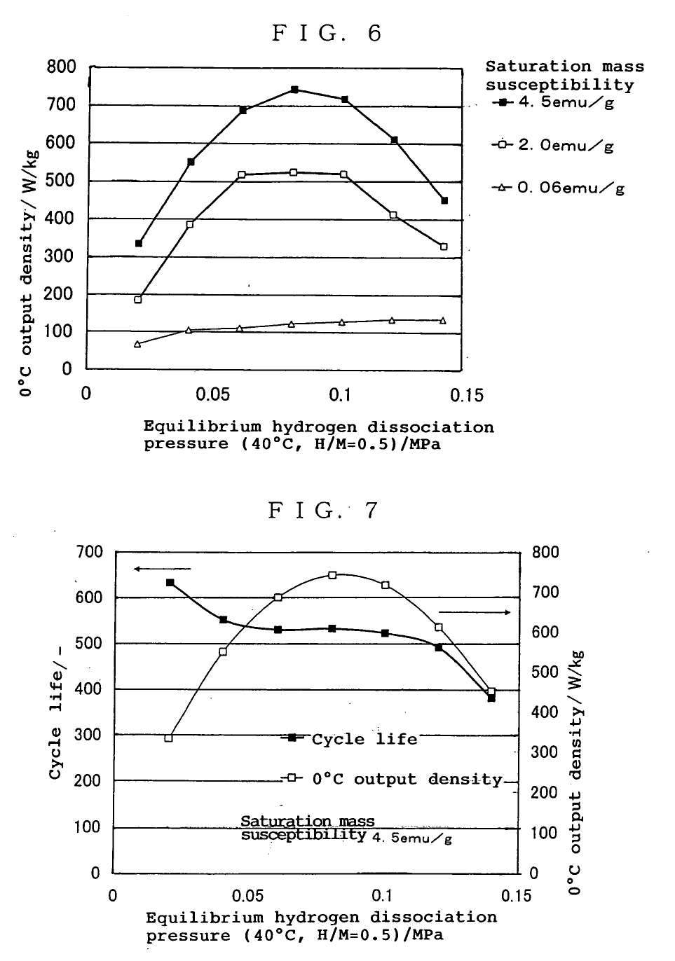

FIG. 6 is a graph illustrating the output densities of Examples 1 through 10 and Comparative Examples 1 through 11 in an atmosphere of 0° C. As seen from FIG. 6, no correlation is observed between the output density and the equilibrium hydrogen dissociation pressure of a hydrogen absorbing alloy powder showing a saturation mass susceptibility is as low as 0.06 emu/g. Then, the output density was as low as 130 W/kg at most. It may be safe to assume that, when the saturation mass susceptibility of hydrogen absorbing alloy powder is so low, the charge transfer reaction on the surfaces of particles of hydrogen absorbing alloy powder is slow and such a result is obtained because a charge transfer function dominates the electrode reaction of the negative electrode.

To the contrary, the output density is by far improved when the saturation mass susceptibility of hydrogen absorbing alloy powder is 2.0 emu/g or 4.5 emu/g if compared with the saturation mass susceptibility of 0.06 emu/g. Additionally, a clear correlation is observed between the output density and the equilibrium hydrogen dissociation pressure and a high output density can be obtained when the equilibrium hydrogen dissociation pressure is not lower than 0.04 MPa at 40° C. and H/M=0.5. It may be safe to assume that, when the equilibrium hydrogen dissociation pressure is high, the absorbed hydrogen therein is bound only weakly so that the hydrogen can move with ease. In a system where the saturation mass susceptibility of hydrogen absorbing alloy powder is high and not less than 2.0 emu/g, the rate-determining step of the electrode reaction of the negative electrode will be gradually shifted to a step of hydrogen diffusion in the hydrogen absorbing alloy powder from the charge transfer reaction to produce a high output density because the charge transfer reaction is accelerated. As shown in FIG. 6, the output density is about 330 W/kg at most in a system where the equilibrium hydrogen dissociation pressure is as low as 0.02 MPa if the saturation mass susceptibility of hydrogen absorbing alloy powder is raised to 4.5 emu/g.

Surprisingly, however, it was found that the output density falls when the equilibrium hydrogen dissociation pressure of hydrogen absorbing alloy powder is excessively high. As seen from FIG. 6, an output density of 400 W/kg or a value close to it can be obtained when the saturation mass susceptibility of hydrogen absorbing alloy powder is not less than 2.0 emu/g and the equilibrium hydrogen dissociation pressure at 40° C. and H/M=0.5 is between 0.04 and 0.12 MPa.

### (Relationship Between Saturation Mass Susceptibility of Hydrogen Absorbing Alloy Powder and Cycle Performance)

Table 3 below shows the results of a cycle test along with the output densities in an atmosphere of 0° C. of Examples 1, 3 and 5 and Comparative Examples 5, 7 and 9.

TABLE 3

| | hydrogen | | equilibrium hydrogen | saturation mass | | |
|---|---|---|---|---|---|---|
| | absorbing alloy | | dissociation pressure | susceptibility | output density | |
| classification | classification | B/A | (MPa) | (emu/g) | (W/kg) | cycle life (cycle) |
| Example 1 | b | 5.20 | 0.04 | 4.5 | 550 | 552 |
| Comp. Example 5 | b | 5.20 | 0.04 | 0.06 | 104 | 345 |
| Example 3 | e | 5.20 | 0.08 | 4.5 | 742 | 532 |
| Comp. Example 7 | e | 5.20 | 0.08 | 0.06 | 121 | 316 |
| Example 5 | g | 5.20 | 0.12 | 4.5 | 611 | 490 |
| Comp. Example 9 | g | 5.20 | 0.12 | 0.06 | 133 | 312 |

While Example 1 and Comparative Example 5, Example 3 and Comparative Example 7 and Example 5 and Comparative Example 9 differ from each other only in terms of saturation mass susceptibility of hydrogen absorbing alloy powder, Examples are by far outstanding than Comparative Examples in terms of output density and cycle life regardless of the level of equilibrium hydrogen dissociation pressure of hydrogen absorbing alloy powder. In the case of Examples, a phase rich of Ni is formed as layer on the surfaces of particles of hydrogen absorbing alloy powder and hence the phase operates as catalyst to accelerate the charge transfer reaction at the negative electrode and is excellent in terms of charge acceptability in a charge operation because the phase provides a passage for hydrogen to pass in the hydrogen absorbing alloy powder so that the electrolyte is prevented from being decomposed and consumed by electrolysis in a charge operation. This is probably why Examples show a better cycle performance than Comparative Examples.

While Comparative Examples 5, 7 and 9 showed a discharge capacity that is 50 to 60% of the rating capacity at the discharge of the first cycle in the charge/discharge cycles at 25° C. in the chemical conversion process, Examples 1, 3 and 5 showed a discharge capacity that is not lower than 90% of the rating capacity. Thus, a nickel metal-hydride battery according to the present invention shows an improved high saturation mass susceptibility because the hydrogen absorbing alloy powder is immersed in an alkaline aqueous solution and hence it has an excellent charge/discharge characteristic immediately after the assemblage. Then, as a result, a nickel metal-hydride battery according to the present invention can accelerate the chemical conversion process and therefore shows a high charge/discharge efficiency in the chemical conversion process so that the reaction of decomposing the electrolyte in the chemical conversion process is suppressed to favorably influence the cycle performance.

### (Relationship of Equilibrium Hydrogen Dissociation Pressure of Hydrogen Absorbing Alloy Powder and Output Power Performance and Cycle Performance)

FIG. 7 illustrates the results of a cycle test along with the output power performance at 0° C. of each of the nickel metal-hydride batteries of Examples 1 through 5 and Comparative Examples 1 and 2. As seen from FIG. 7, the cycle life is degraded as the equilibrium hydrogen dissociation pressure rises probably because the electrolyte is consumed quickly. Surprisingly, however, the degradation of the cycle life is limited when the equilibrium hydrogen dissociation pressure is found within the range between 0.04 and 0.12 MPa at 40° C. and H/M=0.5. Additionally, a cycle life exceeding 400 cycles (close to higher than 500 cycles) can be achieved when the equilibrium hydrogen dissociation pressure is between 0.04 and 0.12 MPa at 45° C. An output density exceeding 500 W/kg can be achieved when the equilibrium hydrogen dissociation pressure is between 0.04 and 0.12 MPa at 40° C. and H/M=0.5 and a cycle life exceeding 400 cycles can be achieved at 45° C. An output density exceeding 600 W/kg can be achieved when the equilibrium hydrogen dissociation pressure is between 0.06 and 0.12 MPa at 40° C. and H/M=0.5 and a cycle life exceeding 400 cycles can be achieved at 45° C. Particularly, a cycle life exceeding 500 cycles can be achieved at 45° C. when the equilibrium hydrogen dissociation pressure is between 0.06 and 0.10 MPa.

### Example 11

The hydrogen absorbing alloy powder d shown in Table 1 was used as hydrogen absorbing alloy powder in Example 1. The hydrogen absorbing alloy powder d was immersed in an NaOH aqueous solution showing a concentration of 48 wt % at temperature of 100° C. for 1.3 hours. The observed saturation mass susceptibility of the hydrogen absorbing alloy powder was 2 emu/g. Otherwise, the process of Example 1 was followed to prepare a nickel metal-hydride battery and subjected to a test as in Example 1. This example is referred to as Example 11.

### Example 12

The hydrogen absorbing alloy powder d was immersed in an NaOH aqueous solution showing a concentration of 48 wt % at temperature of 100° C. for 2 hours in Example 11. The observed saturation mass susceptibility of the hydrogen absorbing alloy powder was 3 emu/g. Otherwise, the process of Example 11 was followed to prepare a nickel metal-hydride battery and subjected to a test as in Example 11. This example is referred to as Example 12.

### Example 13

The hydrogen absorbing alloy powder was immersed in an NaOH aqueous solution showing a concentration of 48 wt % at temperature of 100° C. for 2.6 hours in Example 11. The observed saturation mass susceptibility of the hydrogen absorbing alloy powder was 4 emu/g. Otherwise, the process of Example 11 was followed to prepare a nickel metal-hydride battery and subjected to a test as in Example 11. This example is referred to as Example 13.

### Example 14

The hydrogen absorbing alloy powder was immersed in an NaOH aqueous solution showing a concentration of 48 wt % at temperature of 100° C. for 4 hours in Example 11. The observed saturation mass susceptibility of the hydrogen absorbing alloy powder was 6 emu/g. Otherwise, the process of Example 11 was followed to prepare a nickel metal-hydride battery and subjected to a test as in Example 11. This example is referred to as Example 14.

### Comparative Example 12

The hydrogen absorbing alloy powder was not immersed in a hot alkaline aqueous solution for use in Example 11. The observed saturation mass susceptibility of the hydrogen absorbing alloy powder was 0.06 emu/g. Otherwise, the process of Example 11 was followed to prepare a nickel metal-hydride battery and subjected to a test as in Example 11. This example is referred to as Comparative Example 12.

### Comparative Example 13

The hydrogen absorbing alloy powder was immersed in an NaOH aqueous solution showing a concentration of 48 wt % at temperature of 100° C. for 0.6 hours in Example 11. The observed saturation mass susceptibility of the hydrogen absorbing alloy powder was 1 emu/g. Otherwise, the process of Example 11 was followed to prepare a nickel metal-hydride battery and subjected to a test as in Example 11. This example is referred to as Comparative Example 13.

### Comparative Example 14

The hydrogen absorbing alloy powder was immersed in an NaOH aqueous solution showing a concentration of 48 wt % at temperature of 100° C. for 5.3 hours in Example 11. The observed saturation mass susceptibility of the hydrogen absorbing alloy powder was 8 emu/g. Otherwise, the process of Example 11 was followed to prepare a nickel metal-hydride battery and subjected to a test as in Example 11. This example is referred to as Comparative Example 14.

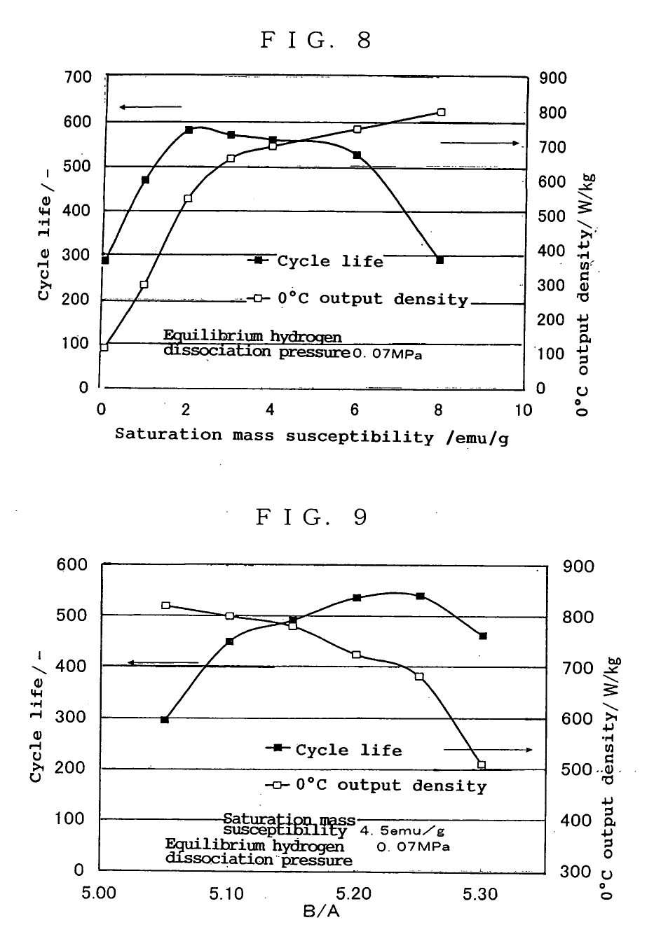

Table 4 shows the obtained physical property values of Examples 11 through 14 and Comparative Examples 12 through 14. FIG. 8 shows the output power performance and the cycle life of each of the nickel metal-hydride batteries in an atmosphere of 0° C.

TABLE 4

| | | | equilibrium | |
|---|---|---|---|---|
| | | | hydrogen | Saturation |
| | hydrogen | | dissociation | mass |
| | absorbing alloy | | pressure | susceptibility |
| classification | classification | B/A | (MPa) | (emu/g) |
| Example 11 | d | 5.20 | 0.07 | 2 |
| Example 12 | d | 5.20 | 0.07 | 3 |
| Example 13 | d | 5.20 | 0.07 | 4 |
| Example 14 | d | 5.20 | 0.07 | 6 |
| Comp. Example 12 | d | 5.20 | 0.07 | 0.06 |
| Comp. Example 13 | d | 5.20 | 0.07 | 1 |
| Comp. Example 14 | d | 5.20 | 0.07 | 8 |

### (Relationship of Saturation Mass Susceptibility of Hydrogen Absorbing Alloy Powder and Output Power Performance and Cycle Performance)

As shown in FIG. 8, hydrogen absorbing alloy powder having a saturation mass susceptibility that is found within a range between 2 and 6 emu/g provides an excellent output power performance that exceeds 500 W/kg at 0° C. and a cycle life exceeding 500 cycles at 45° C. Particularly, an excellent output power performance that exceeds 600 W/kg can be obtained when the saturation mass susceptibility is 3 to 6 emu/g. Therefore, the saturation mass susceptibility of hydrogen absorbing alloy powder should be between 2 and 6 emu/g, preferably between 3 and 6 emu/g. The cycle performance is remarkably degraded when the saturation mass susceptibility is 8 emu/g if compared with a saturation mass susceptibility between 2 and 6 emu/g. While the reason for this is not clear, the inventors of the present invention believe that the number of hydrogen absorbing sites of hydrogen absorbing alloy powder is reduced to degrade the hydrogen absorbing capacity.

### Example 15

The hydrogen absorbing alloy powder j shown in Table 1 was used as hydrogen absorbing alloy powder in Example 1. The hydrogen absorbing alloy powder j was immersed in an NaOH aqueous solution showing a concentration of 48 wt % at temperature of 100° C. for 3 hours. The observed saturation mass susceptibility of the hydrogen absorbing alloy powder was 4.5 emu/g. Otherwise, the process of Example 1 was followed to prepare a nickel metal-hydride battery and subjected to a test as in Example 1. This example is referred to as Example 15.

### Example 16

The hydrogen absorbing alloy powder k shown in Table 1 was used as hydrogen absorbing alloy powder in Example 1. The hydrogen absorbing alloy powder k was immersed in an NaOH aqueous solution showing a concentration of 48 wt % at temperature of 100° C. for 3 hours. The observed saturation mass susceptibility of the hydrogen absorbing alloy powder was 4.5 emu/g. Otherwise, the process of Example 1 was followed to prepare a nickel metal-hydride battery and subjected to a test as in Example 1. This example is referred to as Example 16.

### Example 17

The hydrogen absorbing alloy powder d shown in Table 1 was used as hydrogen absorbing alloy powder in Example 1. The hydrogen absorbing alloy powder d was immersed in an NaOH aqueous solution showing a concentration of 48 wt % at temperature of 100° C. for 3 hours. The observed saturation mass susceptibility of the hydrogen absorbing alloy powder was 4.5 emu/g. Otherwise, the process of Example 1 was followed to prepare a nickel metal-hydride battery and subjected to a test as in Example 1. This example is referred to as Example 17.

### Example 18

The hydrogen absorbing alloy powder 1 shown in Table 1 was used as hydrogen absorbing alloy powder in Example 1. The hydrogen absorbing alloy powder 1 was immersed in an NaOH aqueous solution showing a concentration of 48 wt % at temperature of 100° C. for 3 hours. The observed saturation mass susceptibility of the hydrogen absorbing alloy powder was 4.5 emu/g. Otherwise, the process of Example 1 was followed to prepare a nickel metal-hydride battery and subjected to a test as in Example 1. This example is referred to as Example 18.

### Comparative Example 15

The hydrogen absorbing alloy powder i shown in Table 1 was used as hydrogen absorbing alloy powder in Example 1. The hydrogen absorbing alloy powder i was immersed in an NaOH aqueous solution showing a concentration of 48 wt % at temperature of 100° C. for 3 hours. The observed saturation mass susceptibility of the hydrogen absorbing alloy powder was 4.5 emu/g. Otherwise, the process of Example 1 was followed to prepare a nickel metal-hydride battery and subjected to a test as in Example 1. This example is referred to as Comparative Example 15.

### Comparative Example 16

The hydrogen absorbing alloy powder m shown in Table 1 was used as hydrogen absorbing alloy powder in Example 1. The hydrogen absorbing alloy powder m was immersed in an NaOH aqueous solution showing a concentration of 48 wt % at temperature of 100° C. for 3 hours. The observed saturation mass susceptibility of the hydrogen absorbing alloy powder was 4.5 emu/g. Otherwise, the process of Example 1 was followed to prepare a nickel metal-hydride battery and subjected to a test as in Example 1. This example is referred to as Comparative Example 16.

Table 5 shows the obtained physical property values of Examples 15 through 18 and Comparative Examples 15 and 16. FIG. 9 shows the output power performance and the cycle life of each of the nickel metal-hydride batteries in an atmosphere of 0° C.

TABLE 5

| | | | equilibrium | |
|---|---|---|---|---|
| | | | hydrogen | Saturation |
| | hydrogen | | dissociation | mass |
| | absorbing alloy | | pressure | susceptibility |
| classification | classification | B/A | (MPa) | (emu/g) |
| Example 15 | j | 5.10 | 0.07 | 4.5 |
| Example 16 | k | 5.15 | 0.07 | 4.5 |
| Example 17 | d | 5.20 | 0.07 | 4.5 |
| Example 18 | l | 5.25 | 0.07 | 4.5 |
| Comp. Example 15 | i | 5.05 | 0.07 | 4.5 |
| Comp. Example 16 | m | 5.30 | 0.07 | 4.5 |

### (Relationship of B/A of Hydrogen Absorbing Alloy Powder and Output Power Performance and Cycle Performance)

As shown in FIG. 9, a high output that exceeds 600 W/kg is obtained when the component ratio (B/A) of the non-rare earth elements to the rare earth elements of hydrogen absorbing alloy is not higher than 5.25 in terms of mol ratio. While the reason for this is not clear yet, the inventors of the present invention believe that hydrogen absorbing alloy powder can easily be fissured and is actually partly fissured during the charge/discharge cycles in the initial activation process to allow hydrogen in the alloy powder to quickly move to active sites by transfer on the surfaces of particles of alloy powder where hydrogen can move more quickly than in the inside of alloy. However, particles of alloy powder are apt to be fissured excessively to degrade the cycle life performance when the mol ratio is low. A cycle life that is close to or exceeds 400 cycles can be obtained at 45° C. when the component ratio (B/A) is not less than 5.10 in term of mol ratio. Preferably, a cycle life that is close to or exceeds 500 cycles can be obtained at 45° C. when the component ratio is between 5.15 and 5.25. However, the cycle performance is degraded when the component ratio (B/A) is excessively high and made equal to 5.30 if compared when the component ratio (B/A) is between 5.15 and 5.25 probably because the capacity of alloy falls. Additionally, various alloy characteristics of alloy can become unstable when the component ratio is excessively high because the alloy components can easily be segregated. Therefore, the component ratio (B/A) is preferably not more than 5.25 in terms of mol ratio for the purpose of the present invention.

From the results shown above, the use of hydrogen absorbing alloy containing rare earth elements and transition metal elements as principal components can provide a high output power performance and a long service life in a low temperature region when the component ratio (B/A) is not less than 5.10 and not more than 5.25 and the equilibrium hydrogen dissociation pressure is not less than 0.04 MPa and not more than 12 MPa at 40° C. and H/M=0.5, while the saturation mass susceptibility is not less than 2 emu/g and not more than 6 emu/g.

### Example 19

1 weight portion of Yb₂O₃ powder showing an average particle size of 1 μm was added to and mixed with 100 weight portions of hydrogen absorbing alloy powder instead of the Er₂O₃ powder in Example 3. Otherwise, the composition was the same as Example 3. This example is referred to as Example 19.

### Reference Example 1

Hydrogen absorbing alloy powder and styrenebutadiene copolymer were mixed at a ratio of 99.35:0.65 in terms of solid weight ratio and dispersed into water to produce a paste without adding Er₂O₃ powder to and mixing it with the hydrogen absorbing alloy powder in Example 3. Otherwise, the composition was the same as Example 3. This example is referred to as Reference Example 1.

Table 6 shows the obtained test results (output power performance and cycle performance) of Example 19 and Reference Example 1 along with the test results of Example 3.

TABLE 6

| | addition of Yb or | output density | cycle life |
|---|---|---|---|
| classification | Er hydroxide powder | (W/kg) | (cycle) |
| Example 3 | added by 1 weight portion of | 742 | 532 |
| | Er₂O₃ powder | | |
| Example 19 | added by 1 weight portion of | 671 | 584 |
| | Yb₂O₃ powder | | |
| Reference | nothing added | 740 | 275 |
| Example 1 | | | |

### (Addition of Er₂O₃ Powder or Yb₂O₃ Powder to Hydrogen Absorbing Alloy Powder)

As shown in Table 6, Reference Example 1 is inferior to Examples 3 and 19 in terms of cycle life. It may be because any possible corrosion of hydrogen absorbing alloy powder is suppressed to produce an excellent cycle performance as a result of adding Er₂O₃ powder to the hydrogen absorbing alloy powder of Examples 3 and Ybr₂O₃ powder to the hydrogen absorbing alloy powder of Example 20. Since Example 3 is superior to Example 19 in terms of output power performance, whereas Example 19 is superior to Example 3 in terms of cycle performance, it is preferable to add Er₂O₃ powder when the output power performance is stressed and add Yb₂O₃ powder when the cycle performance is stressed.

### Reference Example 2

The lower current collecting plate is provided with a single projection at the center thereof and hence the lower current collecting plate and the inner surface of the bottom of the container were welded to each other only at the center of the lower current collecting plate in Example 3. Otherwise, the process of Example 3 was followed. This example is referred to as Reference Example 2.

### Comparative Example 17

The ring-shaped lead of Example 20 was replaced by a ribbon-like lead as shown in FIG. 5. The ribbon-like lead was made of a nickel plate having a thickness of 0.6 mm, a width of 15 mm and a length of 25 mm. Before incorporating the lid into (sealing) the battery, the ribbon-like lead, the inner surface of the sealing plate and the upper surface of the upper current collecting plate were welded at respective four welded points. The shortest length of the current collecting lead connecting the welded points of the current collecting lead and the sealing plate and the welded points of the current collecting lead and the upper current collecting plate was about 20 mm (seven times as large as the gap separating the sealing plate and the upper current collecting plate). Otherwise, the process of Example 20 was followed. This example is referred to as Comparative Example 17.

Table 7 shows the obtained test results (output power performance) of Reference Example 2 and Comparative Example 17 along with the test results of Example 3.

TABLE 7

| | | Welded points of lower current collecting | |
|---|---|---|---|
| Classification | Profile of current collecting lead | plate and container | Output density (W/kg) |
| Example 3 | ring-shaped main lead + supplementary | center of lower current collecting plate + 8 | 742 |
| | lead | points | |
| Reference Example 2 | ring-shaped main lead + supplementary | only center of lower current collecting plate | 718 |
| | lead | | |
| Comparative Example 17 | ribbon-like current collecting lead | only center of lower current collecting plate | 649 |

### {Relationship Between Collecting Structure and Output Density (1)}

As shown in Table 7, the sample of Comparative Example 17 is inferior to that of Example 3 and that of Reference Example 2 in terms of output density. Since the same negative electrodes showing an excellent output power performance were used in Example and Comparative Example, the output power performance of battery is not dependent on the characteristics of the negative electrode in such batteries. Therefore, the inferior output power performance of Comparative Example 17 is mainly attributable to the large electric resistance of the current collecting lead that connects the upper current collecting plate and the sealing plate. Example 3 is superior to Reference Example 2 in terms of output power performance. This is probably because of the difference of collecting function of the negative electrodes of the two examples. Thus, a remarkably excellent output power performance can be achieved for a nickel metal-hydride battery when the electric resistance of the current collecting lead is reduced and the collecting function of the negative electrode is enhanced.

### Reference Example 3

The diameter (inner diameter) of the ring-shaped current collecting lead was made equal to 11 mm and the distance separating the eight projections other than the central projection arranged on the lower current collecting plate and the center of the lower current collecting plate was made equal to 7.5 mm in Example 3. A battery same as that of Example 3 was prepared except the above and the output density was measured by the method used for Example 3. The ratio of the distance from the center of the upper current collecting plate to the eight welded points of the current collecting lead (supplementary lead) and the upper current collecting plate to the radius of the electrode assembly was 0.3 and the ratio of the distance from the center of the lower current collecting plate to the eight welded points of the lower current collecting plate and the inner surface of the bottom of the container other than the welded point at the center of the lower current collecting plate to the radius of the electrode assembly was 0.5. This example is referred to as Reference Example 3.

### Reference Example 4

The distance from the center of the lower current collecting plate to the eight welded points of the lower current collecting plate and the inner surface of the bottom of the container other than the welded point at the center of the lower current collecting plate was made equal to 12 mm in Reference Example 3. Otherwise, the process of Reference Example 3 was followed and the output density was measured by the method used for Reference Example 3. The ratio of the distance from the center of the lower current collecting plate to the eight welded points of the lower current collecting plate and the inner surface of the bottom of the container other than the welded point at the center of the lower current collecting plate to the radius of the electrode assembly was 0.8. This example is referred to as Reference Example 4.

### Reference Example 5

The diameter (inner diameter) of the ring-shaped current collecting lead was made equal to 14 mm and the distance separating the eight projections other than the central projection arranged on the lower current collecting plate and the center of the lower current collecting plate was made equal to 6 mm in Example 3. A battery same as that of Example 3 was prepared except the above and the output density was measured by the method used for Example 3. The ratio of the distance from the center of the upper current collecting plate to the eight welded points of the current collecting lead (supplementary lead) and the upper current collecting plate to the radius of the electrode assembly was 0.4 and the ratio of the distance from the center of the lower current collecting plate to the eight welded points of the lower current collecting plate and the inner surface of the bottom of the container other than the welded point at the center of the lower current collecting plate to the radius of the electrode assembly was 0.4. This example is referred to as Reference Example 5.

### Example 20

The distance from the center of the lower current collecting plate to the eight welded points of the lower current collecting plate and the inner surface of the bottom of the container other than the welded point at the center of the lower current collecting plate was made equal to 7.5 mm in Reference Example 5. Otherwise, the process of Reference Example 5 was followed and the output density was measured by the method used for Reference Example 5. The ratio of the distance from the center of the lower current collecting plate to the eight welded points of the lower current collecting plate and the inner surface of the bottom of the container other than the welded point at the center of the lower current collecting plate to the radius of the electrode assembly was 0.5. This example is referred to as Example 20.

### Example 21

The distance from the center of the lower current collecting plate to the eight welded points of the lower current collecting plate and the inner surface of the bottom of the container other than the welded point at the center of the lower current collecting plate was made equal to 12 mm in Reference Example 5. Otherwise, the process of Reference Example 5 was followed and the output density was measured by the method used for Reference Example 5. The ratio of the distance from the center of the lower current collecting plate to the eight welded points of the lower current collecting plate and the inner surface of the bottom of the container other than the welded point at the center of the lower current collecting plate to the radius of the electrode assembly was 0.8. This example is referred to as Example 21.

### Reference Example 6

The distance from the center of the lower current collecting plate to the eight welded points of the lower current collecting plate and the inner surface of the bottom of the container other than the welded point at the center of the lower current collecting plate was made equal to 13.7 mm in Reference Example 5. Otherwise, the process of Reference Example 5 was followed and the output density was measured by the method used for Reference Example 5. The ratio of the distance from the center of the lower current collecting plate to the eight welded points of the lower current collecting plate and the inner surface of the bottom of the container other than the welded point at the center of the lower current collecting plate to the radius of the electrode assembly was 0.9. This example is referred to as Reference Example 6.

### Reference Example 7

The diameter (inner diameter) of the ring-shaped current collecting lead was made equal to 23 mm and the distance separating the eight projections other than the central projection arranged on the lower current collecting plate and the center of the lower current collecting plate was made equal to 6 mm in Example 3. A battery same as that of Example 3 was prepared except the above and the output density was measured by the method used for Example 3. The ratio of the distance from the center of the upper current collecting plate to the eight welded points of the current collecting lead (supplementary lead) and the upper current collecting plate to the radius of the electrode assembly was 0.7 and the ratio of the distance from the center of the lower current collecting plate to the eight welded points of the lower current collecting plate and the inner surface of the bottom of the container other than the welded point at the center of the lower current collecting plate to the radius of the electrode assembly was 0.4. This example is referred to as Reference Example 7.

### Example 22

The distance from the center of the lower current collecting plate to the eight welded points of the lower current collecting plate and the inner surface of the bottom of the container other than the welded point at the center of the lower current collecting plate was made equal to 7.5 mm in Reference Example 7. Otherwise, the process of Reference Example 7 was followed and the output density was measured by the method used for Reference Example 7. The ratio of the distance from the center of the lower current collecting plate to the eight welded points of the lower current collecting plate and the inner surface of the bottom of the container other than the welded point at the center of the lower current collecting plate to the radius of the electrode assembly was 0.5. This example is referred to as Example 22.

### Example 23

The distance from the center of the lower current collecting plate to the eight welded points of the lower current collecting plate and the inner surface of the bottom of the container other than the welded point at the center of the lower current collecting plate was made equal to 12 mm in Reference Example 7. Otherwise, the process of Reference Example 7 was followed and the output density was measured by the method used for Reference Example 7. The ratio of the distance from the center of the lower current collecting plate to the eight welded points of the lower current collecting plate and the inner surface of the bottom of the container other than the welded point at the center of the lower current collecting plate to the radius of the electrode assembly was 0.8. This example is referred to as Example 23.

### Reference Example 8

The distance from the center of the lower current collecting plate to the eight welded points of the lower current collecting plate and the inner surface of the bottom of the container other than the welded point at the center of the lower current collecting plate was made equal to 13.7 mm in Reference Example 7. Otherwise, the process of Reference Example 7 was followed and the output density was measured by the method used for Reference Example 7. The ratio of the distance from the center of the lower current collecting plate to the eight welded points of the lower current collecting plate and the inner surface of the bottom of the container other than the welded point at the center of the lower current collecting plate to the radius of the electrode assembly was 0.9. This example is referred to as Reference Example 8.

### Reference Example 9

The diameter (inner diameter) of the ring-shaped current collecting lead was made equal to 20 mm (outer diameter: 21.6 mm) and an supplementary lead having eight jutted chips radially extending from the outer peripheral surface of the ring-shaped current collecting lead toward the outside and projections arranged at the fronts ends of the respective jutted chips was fitted to the ring-shaped current collecting lead. The length of the projecting part of each of the jutted chips projecting from the outer peripheral surface of the ring-shaped current collecting lead was made equal to 1 mm. The distance from the center of the lower current collecting plate to the eight projections other than the projection at the center of the lower current collecting plate was 7.5 mm. Otherwise, the process of Example 3 was followed to prepare a battery and the output density was measured by the method used for Example 3. The ratio of the distance from the center of the upper current collecting plate to the eight welded points of the current collecting lead (supplementary lead) and the upper current collecting plate to the radius of the electrode assembly was 0.8 and the ratio of the distance from the center of the lower current collecting plate to the eight welded points of the lower current collecting plate and the inner surface of the bottom of the container other than the welded point at the center of the lower current collecting plate to the radius of the electrode assembly was 0.5. This example is referred to as Reference Example 9.

### Reference Example 10

The distance from the center of the lower current collecting plate to the eight welded points of the lower current collecting plate and the inner surface of the bottom of the container other than the welded point at the center of the lower current collecting plate was made equal to 12 m in Reference Example 9. Otherwise, the process of Reference Example 7 was followed and the output density was measured by the method used for Reference Example 7. The ratio of the distance from the center of the lower current collecting plate to the eight welded points of the lower current collecting plate and the inner surface of the bottom of the container other than the welded point at the center of the lower current collecting plate to the radius of the electrode assembly was 0.8. This example is referred to as Reference Example 10.

Table 8 below shows the output densities of Examples 20 through 23 and Reference Examples 3 through 10 along with the output density of Example 3.

TABLE 8

| | welded positions of current collecting lead and upper | welded positions of lower current collecting plate | |
|---|---|---|---|
| | current collecting plate | and container bottom inner surface distance | |
| | distance from center of upper current collecting plate | from center of upper current collecting plate | output density |
| classification | of welded positions/radius of electrode assembly | of welded positions/radius of electrode assembly | (W/kg) |
| Ref. Ex. 3 | 0.3 | 0.5 | 716 |
| Ref. Ex. 4 | 0.3 | 0.8 | 718 |
| Ref. Ex. 5 | 0.4 | 0.4 | 722 |
| Example 20 | 0.4 | 0.5 | 732 |
| Example 21 | 0.4 | 0.8 | 734 |
| Ref. Ex. 6 | 0.4 | 0.9 | 725 |
| Example 3 | 0.6 | 0.7 | 742 |
| Ref. Ex. 7 | 0.7 | 0.4 | 726 |
| Example 22 | 0.7 | 0.5 | 736 |
| Example 23 | 0.7 | 0.8 | 739 |
| Ref. Ex. 8 | 0.7 | 0.9 | 726 |
| Ref. Ex. 9 | 0.8 | 0.5 | 723 |
| Ref. Ex. 10 | 0.8 | 0.8 | 721 |

### {Relationship Between Collecting Structure and Output Density (2)}

As shown in Table 8, the output densities at ambient temperature of 0° C. of Examples 20 through 23 exceeds 730 W/kg that are higher than the corresponding values of Reference Examples 3 through 10. Therefore, it is preferable that the ratio of the distance from the center of the upper current collecting plate to the welded points of the current collecting lead and the upper current collecting plate to the radius of the electrode assembly is between 0.4 and 0.7 and the ratio of the distance from the center of the lower current collecting plate to the plurality of welded points of the lower current collecting plate and the inner surface of the bottom of the container other than the welded point at the center of the lower current collecting plate to the radius of the electrode assembly is between 0.5 and 0.8. With such an arrangement, a nickel metal-hydride battery according to the present invention shows an excellent collecting function probably because the welded points of the current collecting lead and the upper current collecting plate are located near the center of the long sides of the electrode plate connected to the upper current collecting plate and the welded points of the lower current collecting plate and the inner surface of the bottom of the container are also located near the center of the long sides of the electrode plate connected to the lower current collecting plate. Thus, a nickel metal-hydride battery according to the present invention provides a high output density because both the positive electrode plate and the negative electrode plate show an excellent collecting function

### INDUSTRIAL APPLICABILITY

As described in detail above, the present invention provides a sealed nickel metal-hydride battery having a negative electrode that shows an excellent output power performance and an excellent cycle performance and a structure that shows a small electric resistance at the current collecting lead. Such a sealed nickel metal-hydride battery can find a broad scope of industrial applications.

1. A nickel metal-hydride battery including a nickel electrode operating as positive electrode and a hydrogen absorbing electrode containing hydrogen absorbing alloy powder and operating as negative electrode, characterized in that
said hydrogen absorbing alloy powder contains a rare earth element and a non-rare earth metal element including nickel (Ni),
when the atomic ratio (H/M) of the hydrogen absorbed in said hydrogen absorbing alloy powder to the total metal elements contained in the hydrogen absorbing alloy powder is 0.5, the equilibrium hydrogen dissociation pressure of the hydrogen absorbing alloy powder is not less than 0.04 mega pascals (Mpa) and not more than 0.12 MPa at 40° C. and,
the saturation mass susceptibility of said hydrogen absorbing alloy powder is not less than 2 emu/g and not more than 6 emu/g, while
the component ratio of said non-rare earth metal element to said rare earth element is not less than 5.10 and not more than 5.25 in terms of mole ratio.

2. The nickel metal-hydride battery according to claim 1, characterized in that, when the atomic ratio (H/M) of the hydrogen absorbed in said hydrogen absorbing alloy powder to the total metal elements contained in the hydrogen absorbing alloy powder is 0.5, the equilibrium hydrogen dissociation pressure of the hydrogen absorbing alloy powder is not less than 0.06 MPa and not more than 0.10 MPa at 40° C.

3. The nickel metal-hydride battery according to claim 1, characterized in that said saturation mass susceptibility is not less than 3 emu/g and not more than 6 emu/g.

4. The nickel metal-hydride battery according to claim 2, characterized in that said saturation mass susceptibility is not less than 3 emu/g and not more than 6 emu/g.

5. The nickel metal-hydride battery according to claim 1, characterized in that a hydrogen absorbing electrode contains said hydrogen absorbing alloy powder and oxide or oxides or hydroxide or hydroxides of Er and/or Yb added to and mixed with the hydrogen absorbing alloy powder.

6. A method of manufacturing a nickel metal-hydride battery according to claim 1, characterized in that hydrogen absorbing alloy powder containing said rare earth element and non-rare earth metal element including nickel (Ni) is immersed in a caustic alkali aqueous solution at high temperature to make the saturation mass susceptibility thereof not less than 2 emu/g and not more than 6 emu/g.

7. The method of manufacturing a nickel metal-hydride battery according to claim 3, characterized in that hydrogen absorbing alloy powder containing said rare earth element and non-rare earth metal element including nickel (Ni) is immersed in a caustic alkali aqueous solution at high temperature to make the saturation mass susceptibility thereof not less than 3 emu/g and not more than 6 emu/g.

8. The nickel metal-hydride battery according to claim 1, including a rolled electrode assembly and a cylindrical bottomed container having its open end sealed by a lid, the inner surface of the sealing plate of said lid and the upper surface of the upper current collecting plate fitted to the upper rolled end of said electrode assembly being connected to each other by way of a current collecting lead, characterized in that at least either the welded point of the inner surface of said sealing plate and the current collecting lead or the welded point of the current collecting lead and the upper current collecting plate is welded by causing an electric current to flow between the positive electrode terminal and the negative electrode terminal of the battery from an external power source by way of the inside of the battery after sealing the open end of the container.

9. The nickel metal-hydride battery according to claim 5, including a rolled electrode assembly and a cylindrical bottomed container having its open end sealed by a lid, the inner surface of the sealing plate of said lid and the upper surface of the upper current collecting plate fitted to the upper rolled end of said electrode assembly being connected to each other by way of a current collecting lead, characterized in that at least either the welded point of the inner surface of the sealing plate and the current collecting lead or the welded point of the current collecting lead and the upper current collecting plate is welded by causing an electric current to flow between the positive electrode terminal and the negative electrode terminal of the battery from an external power source by way of the inside of the battery after sealing the open end of the container.

10. The nickel metal-hydride battery according to claim 8, characterized in that said current collecting lead and upper current collecting plate are welded at a plurality of welded points, the ratio of the distance from the center of the upper current collecting plate to the welded points to the radius of said rolled electrode assembly is 0.4 to 0.7, a disk-shaped lower current collecting plate is fitted to the lower rolled end of said rolled electrode assembly and the lower current collecting plate and the inner surface of the bottom of the container are welded at a plurality of welded points including one located at the center of the lower current collecting plate and ones located off the center of the lower current collecting plate, and the ratio of the distance from the plurality of welded points other than the one located at the center to the center of said lower current collecting plate to the radius of said rolled electrode assembly is 0.5 to 0.8.

11. The nickel metal-hydride battery according to claim 9, characterized in that said current collecting lead and upper current collecting plate are welded at a plurality of welded points, the ratio of the distance from the center of the upper current collecting plate to the welded points to the radius of said rolled electrode assembly is 0.4 to 0.7, a disk-shaped lower current collecting plate is fitted to the lower rolled end of said rolled electrode assembly, the lower current collecting plate and the inner surface of the bottom of the container are welded at a plurality of welded points including one located at the center of the lower current collecting plate and ones located off the center of the lower current collecting plate, and the ratio of the distance from the plurality of welded point other than the one located at the center to the center of the lower current collecting plate to the radius of said rolled electrode assembly is 0.5 to 0.8.
